(19) United States
(12) Patent Application Publication
(10) Pub. No.: US 2024/0399620 A1
(43) Pub. Date: Dec. 5, 2024

(54) Thermoformable Boron-Based Ceramic Material and Use in Thermal Management

(71) Applicant: Northeastern University, Boston, MA (US)

(72) Inventors: Randall ERB, Newton, MA (US); Jason BICE, Arlington, MA (US)

(21) Appl. No.: 18/689,955

(22) PCT Filed: Sep. 14, 2022
(86) PCT No.: PCT/US2022/043470

§ 371 Date: Mar. 7, 2024

Related U.S. Application Data
(60) Provisional application No. 63/244,223, filed on Sep. 14, 2021.
(60) Provisional application No. 63/289,132, filed on Dec. 13, 2021.
(60) Provisional application No. 63/397,931, filed on Aug. 15, 2022.

(51) Int. Cl. B28B 1/14; B28B 11/00; C04B 35/634; C04B 35/638; C04B 35/64

(52) U.S. Cl. CPC B28B 1/14; B28B 11/005; C04B 35/63452; C04B 35/638; C04B 35/64; C04B 2235/602; C04B 2235/78; C04B 2235/9607

(57) ABSTRACT

In a process for manufacturing molded ceramic composite materials, a preform of a ceramic composite material is provided in which ceramic particles having a platelet configuration are formed within a ceramic matrix. The preform is thermoformed within a mold by heating to a temperature greater than a melting or softening temperature of the ceramic matrix and applying a load to deform the preform to form the molded ceramic composite material in a desired configuration. The process is used to fabricate precisely molded ceramic composite materials and devices containing them. The materials and devices can be used for thermal management, such as for electronic components and other heat generating structures.

### CROSS REFERENCE TO RELATED APPLICATIONS

This application claims benefit under 35 U.S.C. § 119 (e) of U.S. Provisional Application No. 63/397,931, filed on 15 Aug. 2022, entitled “Thermoformable Boron-Based Ceramic Material and Use in Thermal Management”; U.S. Provisional Application No. 63/289,132, filed on 13 Dec. 2021, entitled “Thermoformable Boron-Based Ceramic Material and Use in Thermal Management”; and U.S. Provisional Application No. 63/244,223, filed on 14 Sep. 2021, entitled “Thermoformable Boron-Based Ceramic Material and Use in Thermal Management”, all of which are incorporated by reference herein.

### BACKGROUND

Next-generation high-density electronics, including 5G cellular devices, long range communications, and computer processing chips, are increasingly performance-limited not by current device capability but by an inability to manage heat. Thermal management systems are becoming the innovation bottleneck, especially in electronic applications that have small design envelopes or need to be lightweight. These systems have increasing demands of higher power, higher frequency, and longer duty cycles. Additionally, as the components continue to reduce in size and increase in packing density, the heat fluxes are approaching levels found in nuclear reactors.

The field of ceramic matrix composites (CMCs) continues to expand as a next generation material, particularly for applications in the automotive, aerospace, and electronics industries. As one example, these materials can be used as dielectric thermal encapsulates that sink or spread heat from topographic surfaces of printed circuit boards or other high-density electronics, including power inverters.

To create the complex geometries in ceramics needed for such thermal management applications, several methods are available, such as injection molding, machining, and 3D printing. Thermoforming is an industrial process used to generate complex shell-like structures from molding thin sheets of material known as blanks or preforms via heated compression molding. Thermoforming processes typically use polymer and metal materials for applications such as disposable plates, toys, and interior paneling of cars.

Phononic conductors integrated into ceramic matrix composites (CMCs) have been investigated to provide electrical insulation, while maintaining both thermal conductivity and mechanical strength and toughness. A major drawback to these phononic CMCs is the difficulty to fabricate and machine them into complex, thin, and lightweight geometries that maximize heat transfer.

### SUMMARY

The technology described herein provides processes for manufacturing molded ceramic composite materials and materials and devices, such as thermal management devices, produced by such processes. The technology can overcome difficulties of fabricating complex shapes from ceramic matrix composites (CMCs) into thin and lightweight geometries capable of maximizing heat transfer. The technology employs a tape casting and vibration process that results in a highly oriented and percolated microstructure, which allows for thermoforming of these ceramic composite materials. Thermal management materials and devices so produced can allow for electrical insulation, while maintaining both good thermal conductivity and robust mechanical strength and toughness. Also described are methods of providing thermal management of systems, such as circuit board thermal management.

In some embodiments, a ceramic composite material comprises a boron-based ceramic material, in which hexagonal boron nitride (hBN) particles having a platelet configuration in a parallel alignment are embedded in a boron oxide matrix. The technology makes feasible the fabrication of hBN-based ceramic composite material preforms that can be thermoformed using manufacturing processes traditionally reserved for thermoplastics and sheet metals. Several systematic studies were conducted to characterize the ceramic composite material and processes for manufacturing the material.

The present technology can also be summarized in the following listing of items.

1. A process for manufacturing a molded ceramic composite material, the process comprising:
(a) providing a preform having a first configuration and having two opposed surfaces, the preform comprising a ceramic matrix composite material, the material comprising ceramic particles within a ceramic matrix, wherein the ceramic particles have a platelet configuration disposed in a parallel alignment transverse to a thickness direction extending between the two opposed surfaces of the first configuration;
(b) thermoforming the preform, comprising the steps of:
   (i) heating the preform in a mold to a temperature greater than a melting or softening temperature of the ceramic matrix and preferably less than a melting or degradation temperature of the ceramic particles, and
   (ii) applying a load to the mold, whereby the first configuration of the preform within the mold is converted to a second configuration to form the molded ceramic composite material;
(c) cooling the molded ceramic composite material in the mold; and
(d) removing the molded ceramic composite material from the mold.
   2. The process of item 1, wherein the step of providing the preform comprises:
(a-1) providing a slurry comprising a plurality of the ceramic particles in a polymeric binder;
(a-2) vibrating the slurry to provide a suspension in which the slurry fluidizes;
(a-3) forming the slurry in a layer on a stage or in a preform mold, wherein the ceramic particles become aligned in the parallel alignment;
(a-4) consolidating the polymeric binder to form a solid green body comprising the ceramic particles maintained in the parallel alignment;
(a-5) debinding the solid green body at a first temperature at which the polymeric binder decomposes, leaving a ceramic body comprising the ceramic matrix and the ceramic particles; and
(a-6) sintering the ceramic body at a second temperature greater than the first temperature, whereby the ceramic particles remain in the parallel alignment in the ceramic matrix.
   3 The process of item 2, wherein in step (a-6) the ceramic particles become partially oxidized.
   4. The process of item 2 or item 3, wherein the slurry provided in (a-1) further comprises one or more photoinitiators and one or more diluents mixed together with the ceramic particles and the polymeric binder, and wherein the slurry flows under shear stress.
   5. The process of any of items 2-4, wherein the polymeric binder is selected from the group consisting of a polymerizable resin, an epoxy, a molten thermoplastic, and a solvent-based thermoplastic.
   6 The process of item 5, wherein the polymerizable resin comprises acrylate, methacrylate, polymethyl methacrylate, thiolene resin, epoxy resin, thermoplastic polymer, wax, methylcellulose, phenolic resin, polyvinyl acetate, polyvinyl alcohol, or caoutchouc glue.
   7. The process of any of items 2-6, wherein in the consolidating step of (a-4), consolidating the polymeric binder comprises curing the polymeric binder at a curing temperature to form the solid green body.
   8. The process of any of items 2-7, wherein the polymeric binder is an oxygen-donating material and wherein, in the consolidating step of (a-4), the polymeric binder donates oxygen for seeding an oxidation process at the ceramic particles.
   9. The process of any of items 2-8, wherein the step (a-3) of forming the slurry in the layer comprises tape casting the slurry on the stage or depositing the slurry in the preform mold.
   10. The process of any of items 2-9, wherein the step (a-2) of vibrating the slurry occurs before the step of forming the slurry in the layer, during the step (a-3) of forming the slurry in the layer, after the step (a-3) of forming the slurry in the layer, or a combination thereof.
   11. The process of any of items 2-10, wherein the steps (a-2) of vibrating the slurry and (a-3) of forming the slurry in the layer are repeated a plurality of times to form the sheet.
   12. The process of any of items 2-11, wherein the polymeric binder is a photopolymerizable resin, and the step (a-4) of consolidating the polymeric binder comprises applying ultraviolet or visible light to the slurry.
   13. The process of any of the preceding items, wherein in thermoforming step (b), the temperature to which the preform is heated is below a degradation temperature and/or an evaporation temperature of the ceramic matrix.
   14. The process of any of the preceding items, wherein in thermoforming step (b), the preform is heated to a temperature from about 400° C. to about 1000° C., or from about 500° C. to about 700° C.
   15. The process of any of the preceding items, wherein in step (b) (ii) of applying the load, the load stress ranges from about 50 kPa to about to 100 MPa, or from about 500 kPa to 5 MPa.
   16. The process of any of the preceding items, wherein in thermoforming step (b) the mold comprises a lower part having a negative surface and an upper part having a positive surface, and wherein the load is applied to the preform through the upper part of the mold.
   17. The process of any of the preceding items, wherein in thermoforming step (b), the mold comprises a negative surface and a positive surface, and each surface includes at least one surface feature having a feature size of about 1 mm or less in any dimension.
   18. The process of item 17, wherein said feature size is about 200 μm or less in any dimension.
   19. The process of any of the preceding items, wherein in thermoforming step (b), the mold has a maximum draw ratio of feature height to feature width of about 1 to 1.
   20. The process of any of the preceding items, wherein the ceramic particles comprise an oxide, a nitride, a carbide, a sulfide, a fluoride, or a combination thereof in flake form.
   21. The process of any of the preceding items, wherein the ceramic particles are hexagonal boron nitride, hexagonal aluminum nitride, aluminum oxide, molybdenum disulfide, clay, cesium oxide, graphene, flake-like ferrites, calcium phosphate flakes, zirconia flakes, silica flakes, or a combination thereof.
   22. The process of any of the preceding items, wherein the ceramic matrix comprises boron oxide, silicon dioxide, glass flake, silver coated glass flake, a lithium oxide-silica mixture, a magnesium oxide-silica mixture, or a combination thereof.
   23. The process of any of the preceding items, wherein the ceramic matrix comprises a glassy material or a glassy-ceramic material mixture having a softening phase or melting temperature within a working service temperature range of a material forming the mold and below a melting temperature or degradation temperature of the ceramic particles.
   24. The process of any of the preceding items, wherein the ceramic particle concentration in the molded ceramic composite material is from about 30 wt % to about 90 wt % and the ceramic matrix concentration is from about 10 wt % to about 70 wt %.
   25. The process of any of the preceding items, wherein the ceramic particles in the molded ceramic composite material have a diameter from about 1 μm to about 100 μm, or from about 5 μm to about 45 μm, and a thickness from about 3 to about 100 times less than the diameter.
   26. The process of any of the preceding items, wherein the preform has a thickness from about 0.05 mm to about 10 mm, or from about 0.1 mm to 3 mm.
   27. The process of any of the preceding items, wherein the molded ceramic composite material has a thickness from about 0.05 mm to about 10 mm, or from about 0.1 mm to about 3 mm.
   28. The process of any of the preceding items, wherein the ceramic particles comprise phononic crystal particles.
   29. The process of any of the preceding items, wherein transverse bonds between layers of the ceramic particles within the preform are sufficiently weak to allow slippage of the ceramic particles when subjected to the load in thermoforming step (b) (ii).
   30. The process of any of the preceding items, wherein the molded ceramic composite material has an in-plane thermal conductivity, transverse to the thickness dimension, greater than a through-plane thermal conductivity.
   31. The process of any of the preceding items, wherein the molded ceramic composite material has an in-plane thermal conductivity, transverse to the thickness dimension, from about 5 W/mK to about 100 W/mK, or from about 10 W/mK to about 40 W/mK, at ambient temperature.
   32. The process of any of the preceding items, wherein the molded ceramic composite material is configured as a thermal management device, a heat sink or a heat spreader for a printed circuit board, a heat exchanger, a cold plate, a low-loss dielectric RF component, a radome, a power inverter, a solar cell, a neutron shield, a high temperature heat shield, a heat shield for a cube satellite, an encapsulant, or a medical device.
   33. A method of fabricating a thermal management device for a heat producing component, the method comprising:
(a) providing a mold configured to conform to at least a portion of the heat producing component; and
(b) fabricating a molded ceramic composite material according to the process of any of the preceding items using the mold provided in present step (a) to form the thermal management device.
   34. The method of item 33, further comprising:

(c) fitting the molded ceramic composite material to the heat producing component or portion thereof.

35. The method of item 33 or item 34, wherein the heat producing component is a printed circuit board, a central processing unit, a high-density electronic platform, an electronic chassis, an RF device, an RF or phased antenna array, a low-loss dielectric RF component, a radome, a power inverter, a solar cell, a neutron shield, a cube satellite, or a medical device.
36. A method of fabricating a thermal management device, the method comprising:
(a) providing a design for a heat producing component or portion thereof requiring thermal management;
(b) fabricating a preform mold designed to conform to a first configuration complementary to the heat producing component or portion thereof;
(c) fabricating a mold designed to conform to a second configuration complementary to the heat producing component or portion thereof, wherein the second configuration is more precisely complementary to the heat producing component or portion thereof than the first configuration;
(d) fabricating a preform using the preform mold, wherein the preform has said first configuration and has two opposed surfaces, wherein the preform comprises a ceramic matrix composite material, the material comprising ceramic particles within a ceramic matrix, wherein the ceramic particles have a platelet configuration disposed in a parallel alignment transverse to a thickness direction extending between the two opposed surfaces;
(e) thermoforming the preform within the mold to provide a thermal management device in said second configuration, said thermoforming comprising
   (i) heating the preform in the preform mold to a temperature greater than a melting or softening temperature of the ceramic matrix, and
   (ii) applying a load to the preform mold, whereby the first configuration of the preform within the mold is converted to the second configuration to form the thermal management device;
(f) cooling the thermal management device in the mold; and
(g) removing the thermal management device from the mold.
   37. The method of item 36, wherein in step (a) the design comprises a negative geometry of the heat producing component or portion thereof provided by a three-dimensional computer-aided design model of the heat producing component or portion thereof or through a three-dimensional scan of the heat producing component or portion thereof.
   38. The method of item 36 or item 37, wherein step (b) comprises fabricating the preform mold and/or the mold from a metal material by an additive manufacturing process or a machining process based on a three-dimensional computer-aided design model of the design of the heat producing component or portion thereof.
   39. The method of item 38, wherein the additive manufacturing process is a three-dimensional printing process, a stereolithography process, a direct write process, a fused deposition process, or a selective sintering process with heat or laser.
   40. A device for thermal management of a heat producing component, wherein the device is fabricated by the process of any of the preceding items.
   41. A device for thermal management of a heat producing component, the device comprising:
a body comprising a ceramic matrix composite material, the material comprising a plurality of ceramic particles within a ceramic matrix and comprising two opposed surfaces, the ceramic particles having a platelet configuration disposed in parallel alignment and transverse to a thickness direction extending between the two opposed surfaces; and
wherein the body is formed with at least one deformation to accommodate a surface feature of said component, the parallel alignment of the platelet configuration conforming to at least one dimension of the at least one deformation.
   42. The device of item 41, wherein the ceramic particles comprise hexagonal boron nitride, boron oxide, hexagonal aluminum nitride, aluminum oxide, molybdenum disulfide, clay, cesium oxide, graphene, flake-like ferrites, calcium phosphate flakes, zirconia flakes, silica flakes, or a combination thereof.
   43. The device of item 41 or item 42, wherein the ceramic matrix comprises boron oxide, silicon dioxide, glass flake, silver coated glass flake, a lithium oxide-silica mixture, a magnesium oxide-silica mixture, or a combination thereof.
   44. The device of any of items 41-43, wherein the ceramic particle concentration in the ceramic matrix composite material of the body is from about 30 wt % to about 90 wt % and the ceramic matrix concentration in the ceramic matrix composite material of the body is from about 10 wt % to about 70 wt %.
   45. The device of any of items 41-44, wherein the ceramic particles in the ceramic matrix composite material of the body have a diameter from about 1 μm to about 100 μm, or from about 5 μm to about 45 μm, and a thickness from about 3 to about 100 times less than the diameter.
   46. The device of any of items 41-45, wherein the body has a thickness from about 0.05 mm to about 10 mm, or from about 0.1 mm to 3 mm.
   47. The device of any of items 41-46, wherein the ceramic particles comprise phononic crystal particles.
   48. The device of any of items 41-47, wherein the body has an in-plane thermal conductivity, transverse to the thickness dimension, greater than a through-plane thermal conductivity.
   49. The device of any of items 41-48, wherein the body has an in-plane thermal conductivity, transverse to the thickness dimension, from about 5 W/mK to about 100 W/mK, or from about 10 W/mK to about 40 W/mK, at ambient temperature.

### DESCRIPTION OF THE DRAWINGS

FIGS. 1A-1F show steps to provide a preform in a process for manufacturing a ceramic composite material. FIG. 1A is a schematic illustration in which, on the left, a slurry comprising ceramic particles in a polymerizable resin is deposited on a stage, and on the right, a vibration is applied to the slurry on the stage to fluidize the particles in the resin. FIG. 1B is a schematic illustration in which the slurry is tape cast into a first configuration in the form of a thin sheet or layer showing the particles in a parallel alignment. FIG. 1C shows a photomicrograph illustrating particle alignment during tape casting. FIG. 1D is a schematic illustration in which the slurry in the first configuration is cured to polymerize the resin. FIG. 1E is a schematic embodiment of an apparatus suitable for vibrating, tape casting, and curing the preform. FIG. 1F shows a next step in which the cured preform is sintered to form a fully sintered preform.

FIGS. 2A-2B show steps to thermoform a preform comprising a ceramic composite material. FIG. 2A shows, on the left, two fully sintered preforms, and on the right, one fully sintered preform placed into a two-part mold for thermoforming. FIG. 2B shows, on the left, the result of an application of a load to an upper part of the mold to compress the preform within the mold, and on the right, the deformed ceramic matrix composite material removed from the mold.

FIG. 3 is a schematic illustration of phononic conduction of aligned particles in a matrix.

FIG. 4 is a series of scanning electron micrographs illustrating particle alignment based on particle diameter.

FIG. 5A is a schematic illustration of a photopolymerization step. FIG. 5B are graphs of cure depths vs. energy for different particle concentrations and different particle diameters. For the 12 μm particle system, 15 seconds cured a layer thickness of about 250 μm, giving a cure time of 22.5 seconds per layer.

FIG. 6A is a schematic illustration of a sintering step. FIG. 6B illustrates variations in atomic composition of carbon (C), boron (B), oxygen (O), and nitrogen (N) during sintering for sintered hBN, a green body of 54 vol % Ebecryl 230, and sintered 54 vol % Ebecryl 230.

FIGS. 7A and 7B are schematic illustrations of the microstructure of a preform that allows for in-plane flow during the thermoforming process.

FIG. 8A illustrates a phase diagram under a load pressure of ˜0.5 kPa for determining feature sizes based on temperature during thermoforming. FIG. 8B schematically illustrates a mold showing identifications of feature width, height, and length.

FIG. 9 shows top and bottom mold halves for a fine-featured mold and molded ceramic composite materials molded at 500° C., 600° C., and 700° C.

FIG. 10A shows two examples of a coarse-featured mold, the mold on the left having a 90° step and a largest step height of 5 mm, the mold on the right having a fillet with a 1 mm radius, and a molded ceramic composite material molded in each mold at 500° C. At 500° C., the boron-based ceramic composite material could be molded without tearing over even the most aggressive step (width of 5.8 mm, depth of 5 mm, and a sharp 90° bend). Of note, the sample was able to also pick up the mold surface features from the 3D printing process. FIG. 10B shows a fractured edge of a thermoformed heat sink formed in a large feature mold. FIG. 10C shows a scanning electron micrograph (SEM) of a sample deformed in large feature mold.

FIG. 11 is a schematic illustration of a deep drawing mold for thermoforming a preform.

FIGS. 12A-12C are schematic illustrations of a process to fabricate a thermal management device for a printed circuit board.

FIG. 13 shows graphs of flexural strength (i), strain (ii), and resistance (iii) for molded ceramic matrix composite materials at dwell times of 4 hours and 6 hours and of a prior art commercially available boron nitride based all-ceramic material without microstructural control.

FIG. 14 is a graph of deformation of boron-based ceramic preforms measured in a simply loaded flexural case (see inset) at elevated temperatures (Tₘ=450° C.). Deflections were recorded after 10 minutes of dwell time and found to follow a linear trend with a yield point related to a 0.015 N load.

FIG. 15 is a graph of maximum draw ratio vs. estimated stress measured across temperatures of 500° C. to 700° C. and across mold sizes.

FIGS. 16A and 16B depict steps in testing performance of thermoformed boron-based ceramic composite material heat spreaders. 1) A 3D model of a Raspberry Pi (RPi) PCB was used to create a relief mold to encase the chip set on the PCB surface. The height variations of the created positive relief of the RPi are shown with the hatching key. 2) Both positive and negative designed relief molds were then 3D metal printed. Inconel 625 was selected here to withstand the thermal stresses from the thermoforming process. 3) A preform sheet, fabricated by the process shown in FIGS. 1A-1F, was placed between the negative (bottom) and positive (top) relief mold in the oven at 500° C. After a 10-minute dwell time, the positive (top) relief mold was pressed down onto the preform. The mold was then removed from the oven and cooled. The thermoformed ceramic composite material could then be removed. 4) The thermoformed ceramic composite material was post-processed with a wire saw, cutting the formed pattern to the final form that was used in testing.

FIG. 17A is a graph of temperature vs. time for a control prior art heat sink, a prior art metal heat sink, and a thermoformed heat sink. FIG. 17B is a graph of change in temperature per height on a logarithmic scale vs. time for a prior art metal heat sink and a thermoformed heat sink.

FIG. 18A depicts a human face mold shown with positive and negative mold halves open and with the mold shown closed. FIG. 18B depicts a human face mold and a molded ceramic composite material formed within the mold (shown between the two mold parts).

FIG. 19 depicts several deep drawing molds used to mold ceramic composite materials described herein.

FIGS. 20A and 20B are XRD plots of A) a sample prior to the decomposition process showing the presence of hBN and B₂O₃, and B) a sample after decomposition showing only the existing of hBN peaks in the sample, corroborating a successful decomposition.

FIG. 21 depicts an array of samples at different drawing depths in a deep drawing process.

FIG. 22A is a graph of average surface temperature vs. time for a prior art metal heat sink and a thermoformed ceramic composite material heat sink. FIG. 22B depicts thermal images of the heat sinks of FIG. 22A.

FIG. 23 show an experimental setup in which a sintered hBN sample with a mass loaded on top is heated with a propane torch on a bottom surface of the sample.

FIG. 24 depicts a thermoforming process step using a U-shaped mold.

### DETAILED DESCRIPTION

The technology described herein provides processes for manufacturing a variety of molded ceramic composite materials in geometries useful in applications such as thermal management. The technology provides a ceramic composite material with a textured microstructure that enables the material to be formed into complex geometries from a preform of fully sintered ceramic through a heating and molding process. The technology can take advantage of the melting temperature difference between a ceramic matrix and aligned ceramic filler particles in the matrix to provide thermal forming of a ceramic composite material. Microstructure alignment control during processing contributes to deformations due to particle slippage between the matrix-particle interface. The composite ceramic material can exhibit typical ceramic characteristics and can also be sufficiently ductile under relatively low temperatures and can solidify to a molded geometry, without fracture.

Ceramics tend not to have melting transitions at moderate temperatures due to their covalently bonded atomic structures. In contrast, as described herein, glassy ceramics such as boron oxide (B₂O₃), due to their amorphous characteristic and lower melting temperatures (450° C. for B₂O₃), can be formed using molding and pressing processes with well-defined shapes. The present technology uses glassy-ceramic matrix solutions with high particle filler (inclusion) concentrations. These composite materials have an amorphous ceramic matrix in which are embedded anisotropic filler particles, which can be thermally conductive. In some embodiments, hexagonal boron nitride (hBN) is a suitable filler particle. Boron oxide is a glassy-ceramic material that forms as an oxide layer on boron nitride as the surrounding temperature reaches 1000° C. Thus, the boron nitride can be partially oxidized to form a robust, glassy-ceramic composite that can withstand substantial thermal shock, in addition to having large deformations above the melting temperature of the B₂O₃ matrix. The oxide acts as a binding agent between the hBN particles, providing a strengthening mechanism for the post-sintered part. Further, the amorphous oxide matrix is significantly weaker than the boron nitride particles, allowing for a toughening mechanism of the ceramic. With the boron oxide used as a binder, the highly aligned hBN microparticles can form thermally percolated networks.

Thus, the present technology provides a ceramic composite material that can be thermoformed into a variety of configurations. Additionally, the processes described herein can go beyond in-situ glassy-oxide formation, extending to other ceramic matrix composites that are capable of being thermoformed and of sustaining thermal cycles for an array of extreme environment applications.

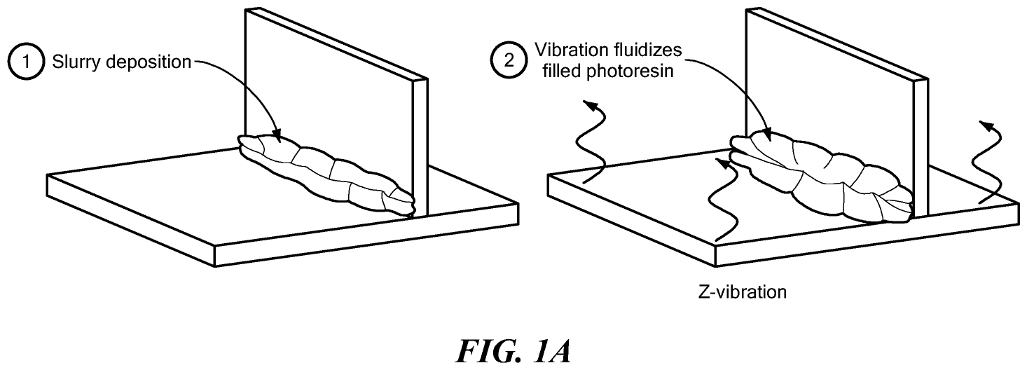

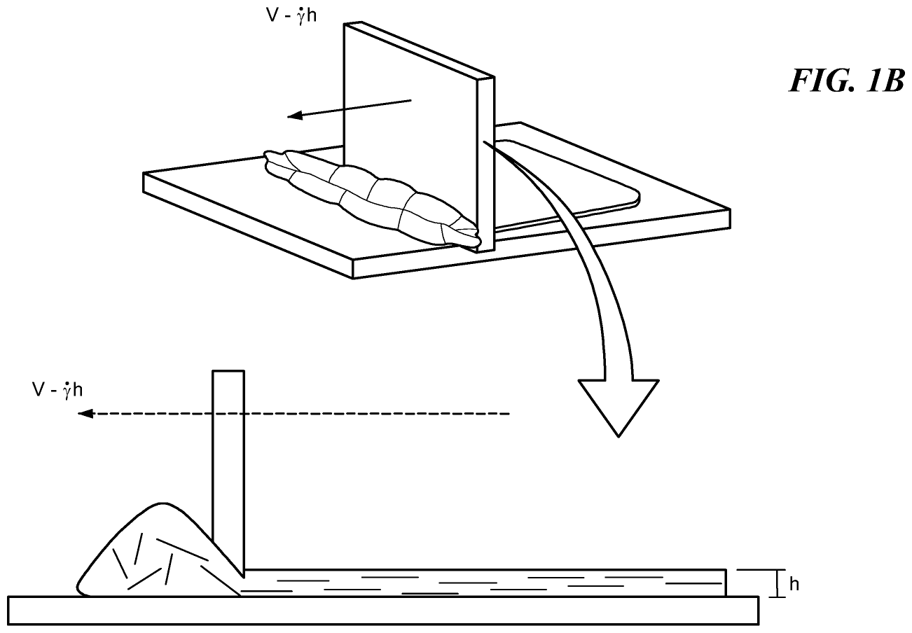

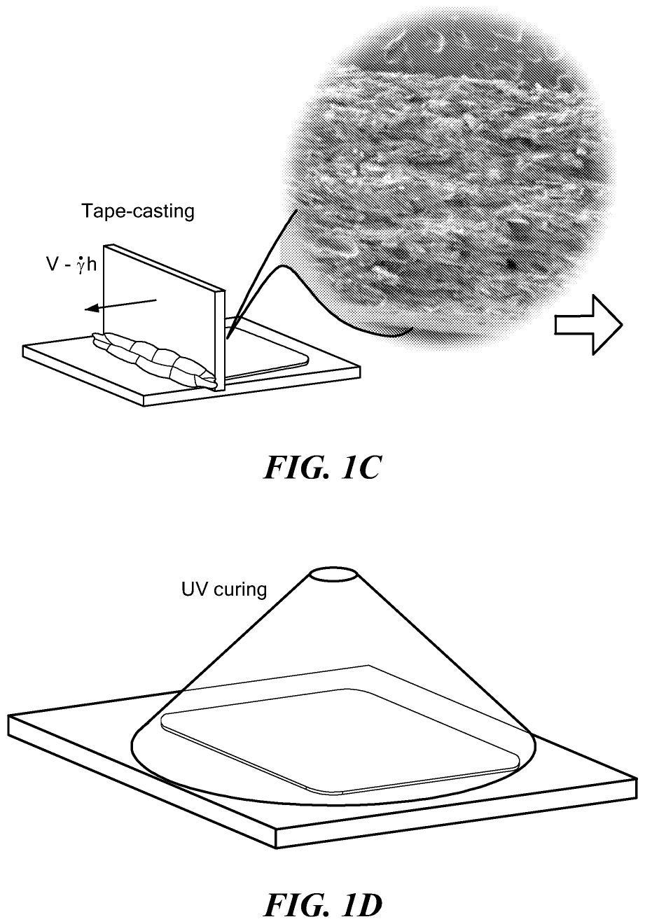

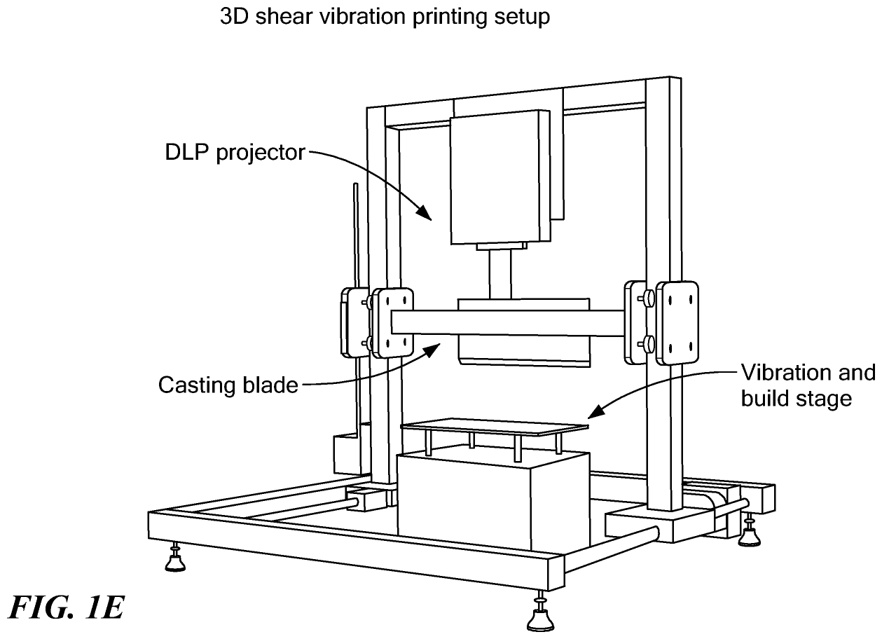

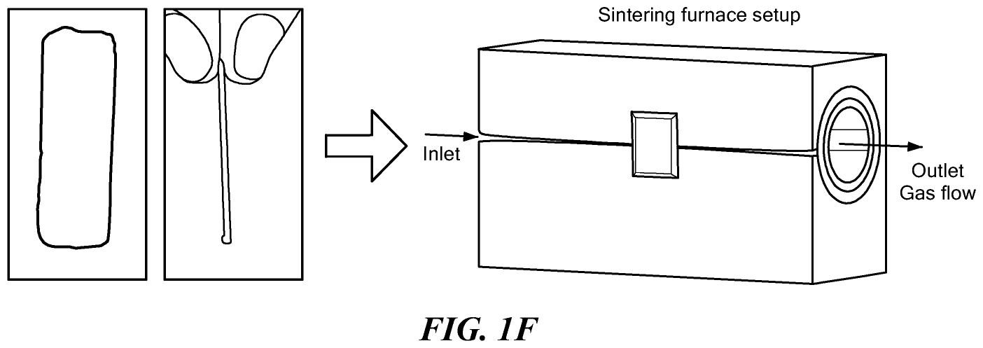

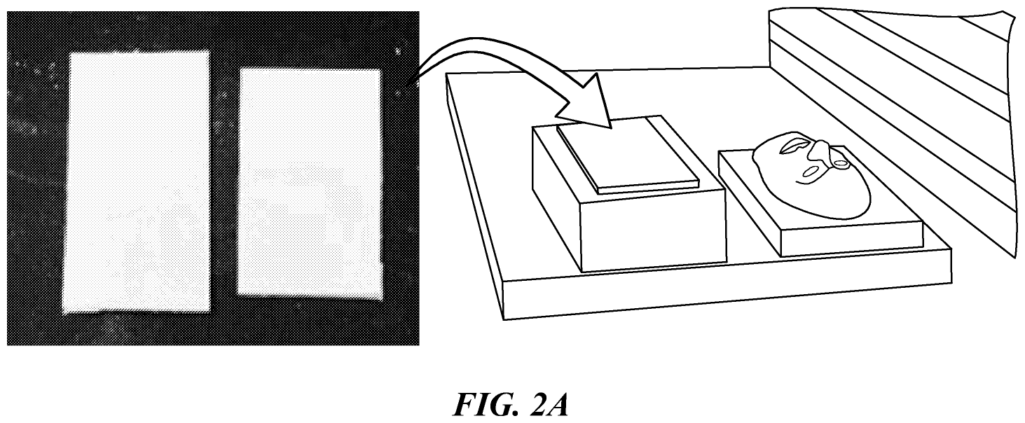

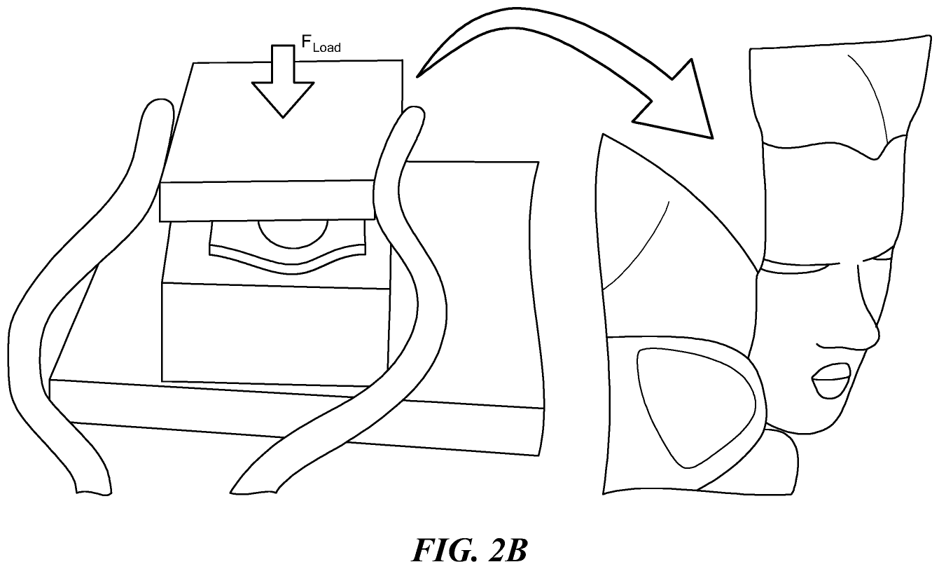

Embodiments of a process for manufacturing a thermal management device from ceramic matrix composites (CMCs) can be described with reference to FIGS. 1A-2B. In a first step, the process provides a preform comprising a ceramic composite material, the material comprising ceramic particles within a ceramic matrix. The ceramic particles have a platelet or flake configuration. The preform can be configured in a first configuration having two opposed surfaces, such as a sheet or layer having a thickness between the two opposed surfaces. The first configuration can have an in-plane direction perpendicular to the thickness direction and a through-plane direction parallel to the thickness direction. The ceramic particles having the platelet or flake configuration can be disposed in a parallel alignment with the in-plane direction. In some embodiments, the parallel alignment of the particles can be substantially parallel to the through-plane direction, such as within 10%, within 5%, within 2%, within 1%, or within 0.5%.

More particularly, a plurality of the ceramic particles and a polymeric binder are mixed into a slurry which is deposited in a layer on a surface, such as on a stage or in a mold. (FIG. 1A) In some embodiments, the slurry can be tape cast onto the stage. In some embodiments, the slurry can be deposited onto a surface of a mold. The slurry is vibrated on the surface to form a suspension in which the ceramic particles become aligned in the parallel alignment with each other and transverse to the thickness direction. The vibration allows for enhanced fluidization, and the tape casting then concurrently shear aligns the particles. (FIGS. 1A, 1B, 1C) In some embodiments, shear alignment improves with a smaller thickness. In some embodiments, shear alignment improves with higher ratio α, particle diameter to thickness, where α=D/h, D is the two-dimensional particle diameter, and h is the tape cast layer height.

In some embodiments, the vibration can be applied in a direction parallel to the layer thickness or the through-plane direction of the preform. In some embodiments, the vibration can be applied in one or more directions parallel to the in-plane direction of the preform. In some embodiments, the vibration can be applied in one or more of any three-dimensional direction. The vibration can be applied before tape casting, during tape casting, or after tape casting, or a combination thereof.

The polymeric binder is consolidated to form a solid green body of the ceramic particles maintained in the parallel alignment. In some embodiments, the polymeric binder is a polymerizable resin, and the preform is heated to a first temperature to cure the polymerizable resin and to form the solid green body with the ceramic particles maintained in the parallel alignment. (FIG. 1D) In some embodiments, the resin is cured by exposure to ultraviolet radiation, visible radiation, or a combination thereof. In some embodiments, the slurry can be deposited in multiple layers, in an additive process in which each layer can be subject to vibration, tape casting, and curing. This can aid in providing a layer-by-layer particle alignment. An embodiment of an apparatus that can be used to vibrate and tape cast the slurry and provide curing by exposure to a suitable radiation using a digital light projector (DLP) is illustrated in FIG. 1E. The apparatus can be used to build the material up in multiple layers. In some embodiments, a nominal particle diameter can be at least about 1 μm. In some embodiments, a particle thickness can be at least about 300 nm. In some embodiments, a particle diameter can be about 5 μm, about 12 μm, or about 45 μm. In some embodiments, a layer thickness can be at least about 30 μm. In some embodiments, a layer thickness can range from about 30 μm to about 3 mm. In some embodiments, a layer thickness can be about 100 μm, about 500 μm, about 1 mm, about 2 mm, or about 3 mm. In some embodiment, dimensional tolerances can be 20%, 10%, 5%, 1%, or 0.5%.

The solid green body is then sintered at a second temperature greater than the first temperature (FIG. 1F) to partially oxidize the ceramic particles and to provide a fully sintered body with the ceramic particles maintained in the parallel alignment in the ceramic matrix. In some embodiments, seeding oxygen from the polymer binder burnout in the curing step can provide homogeneous oxidation during the sintering process. In some embodiments, the polymer used in the slurry to produce a preform does not need to be photosensitive, if the polymer is a sufficiently oxygen-rich formulation, such that the trapped excess oxygen can be used as a catalyst during the sintering process. In some embodiments, a glassy-ceramic additive can be seeded throughout the slurry mixture to form the glassy matrix, with or without the use of a sintering aided process using an oxygen rich polymer.

Referring to FIGS. 2A-2B, the preform is then placed in a mold for thermoforming to produce a molded ceramic composite material with a desired three-dimensional configuration. In some embodiments, the mold can have two halves providing a positive mold or mold surface with one or more convex curves and a negative mold or mold surface with one or more concave curves. In some embodiments, the mold surfaces can include one or more steps. The two mold halves have a geometric offset from each other that allows for the preform to be press fit in between the two mold halves. In some embodiments, a mold can be formed by an additive manufacturing process, such as 3D printing, from a metal material capable of withstanding the molding temperatures. Suitable metal materials include Inconel, an austenitic nickel-chromium-based superalloy, and 304 stainless steel. In the thermoforming step, the preform in the mold is heated to a temperature greater than the melting temperature of the ceramic matrix. A load is applied to the mold to deform the preform within the mold. In some embodiments, the load is applied to the preform through the positive mold. The alignment of the ceramic particles in the microstructure of the preform allows for in-plane flow of the particles during the thermoforming process. The molded ceramic composite material is cooled and removed from the mold. In some embodiments, a molded ceramic composite material can be thermoformed from a flat, sintered sheet within 15 minutes. In some embodiments, a ceramic composite material can be thermoformed from a flat, sintered sheet within 10 minutes. In some embodiments, a ceramic composite material can be thermoformed from a flat, sintered sheet in less than 10 minutes. In some embodiments, in the thermoforming step, the preform is heated to a temperature from about 400° C. to about 1000° C. In some embodiments, the preform is heated to a temperature from about 500° C. to about 700° C.

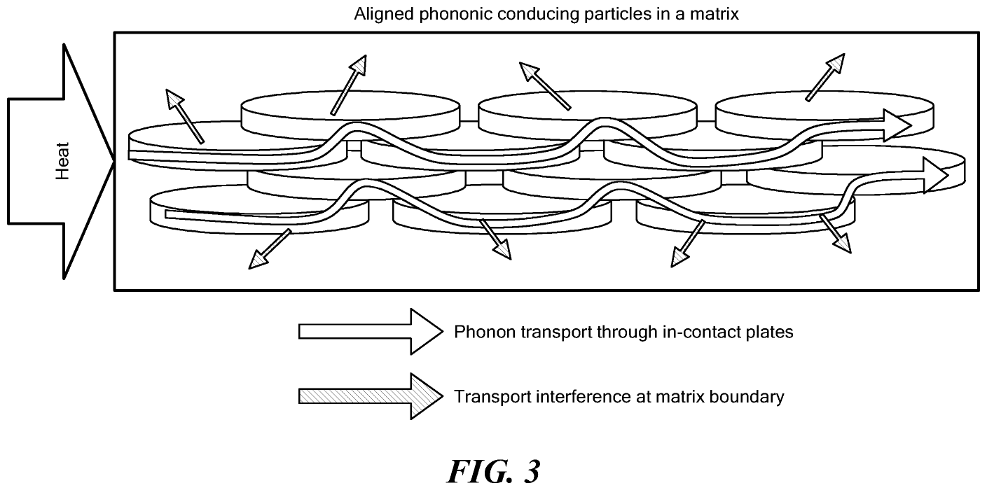

In some embodiments, as noted above, hexagonal boron nitride (hBN) can be selected as the ceramic particles and boron oxide (B₂O₃) as the ceramic matrix, although it will be appreciated that embodiments of the process can be used with other ceramic particles and matrix materials. Aligned platelet particles of hBN are efficient in phononic transport in-plane due to an atomic structure composed of covalent bonds between the boron and nitrogen atoms in a honeycomb structure. These honeycombed atomic sheets are transversely bound by weaker pi-bonds, increasing phononic scattering in the transverse direction. (FIG. 3) The thermal anisotropy in hBN stipulates that the thermal behavior of the phononic material is dictated by the underlying microstructure including the orientation and percolation of the hBN particles.

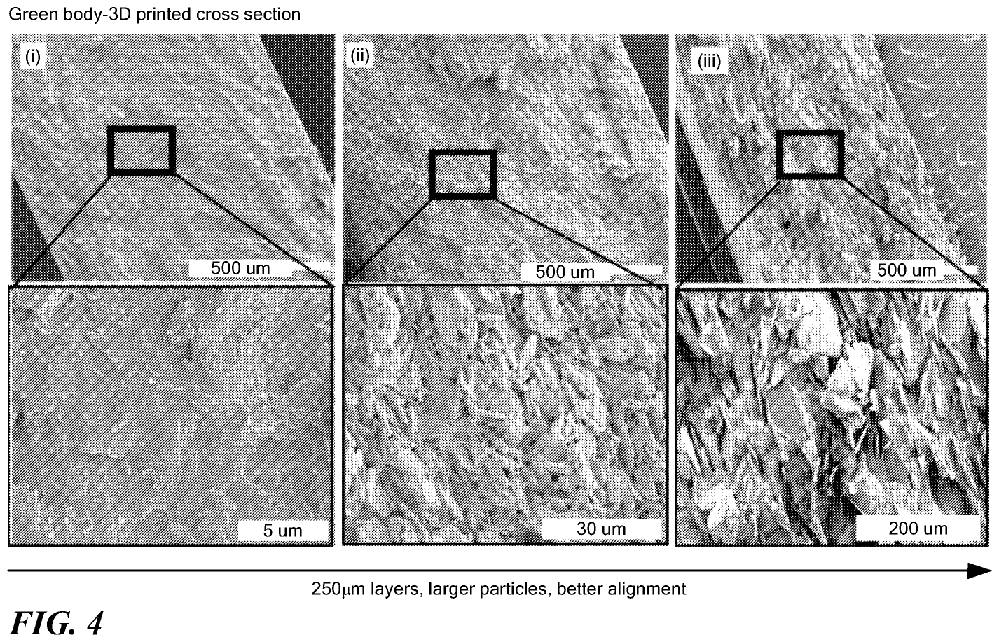

To achieve the desired particle orientation and percolation throughout the ceramic composite material, a vibration-assisted casting method can align high volume fractions of hBN particles (in some embodiments, as much as 60 vol %) in polymeric green bodies. These high loadings of hBN particles suspended in liquid binder resin (e.g., a photoresin or an epoxy) behave as Hershel-Buckley fluids, requiring shear in the form of vibration to effectively flow. Further, these dense particle suspensions are subjected to vibration energies during the tape casting process to further fluidize and shear align the hBN in-plane to a high degree. FIG. 4 illustrates photomicrographs of the alignment of hBN particles in a 250 μm layer having nominal particle diameters of, from left to right, 5 μm, 12 μm, and 45 μm. The larger diameter particles provide better alignment and act as a director for the smaller particles within the polydispersed particle system.

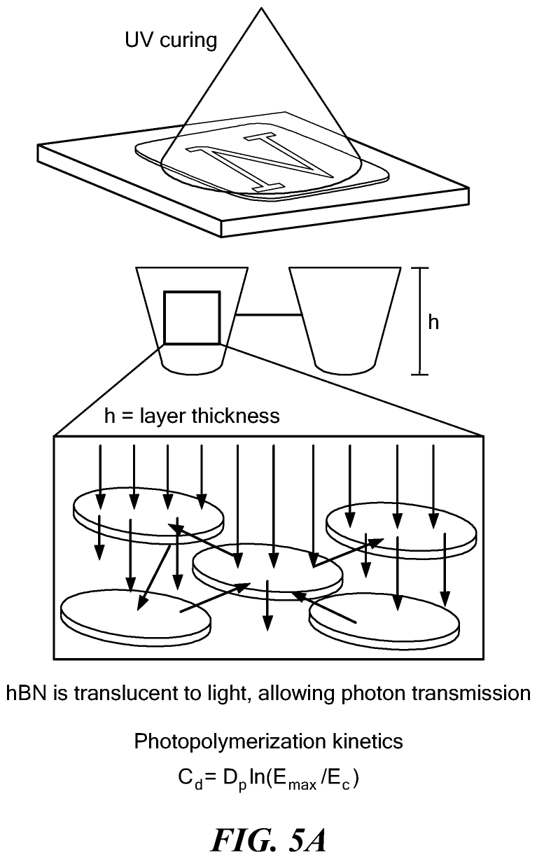

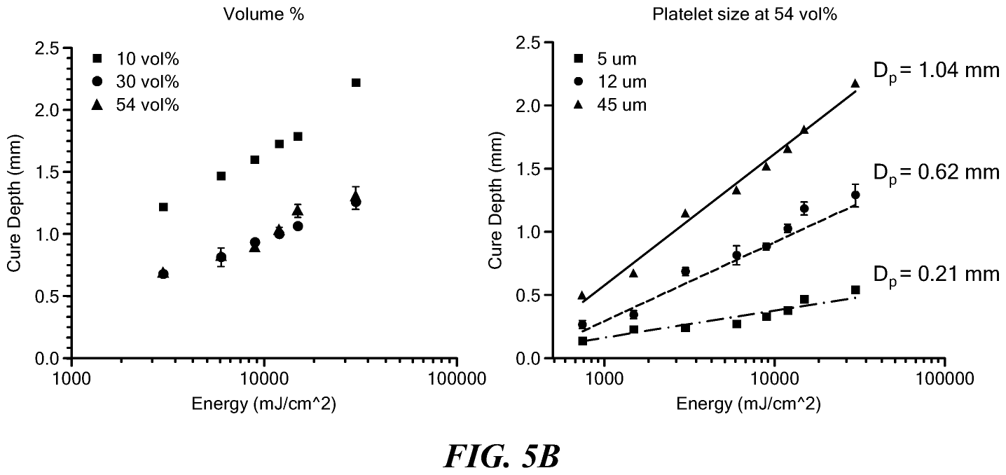

After tape casting, the suspension is subjected to UV light to polymerize the photoresin, locking in the oriented hBN particles into a solid green body. In some embodiments, the material is exposed to UV-A and visible UV radiation with a peak wavelength of 405 nm. The hBN platelets are translucent to visible light (see FIG. 5A). Characterizing photokinetics can illustrate the relationship between particle concentration and particle size with respect to the cure depth. For example, as the particle concentration increases, in some embodiments, above 30 vol % for hBN particles, the cure depth can become more constrained. As the particle size decreases, the cure depth also decreases, which is related to the light scattering effects as the particles become smaller. In some embodiments, a layer thickness of ˜250 μm and an hBN particle size of 12 μm can be cured in 22.5 seconds (see FIG. 5B). In some embodiments, a multi-layer preform with a thickness of 1 mm and an hBN particle size of 12 μm can be fully cured within one hour.

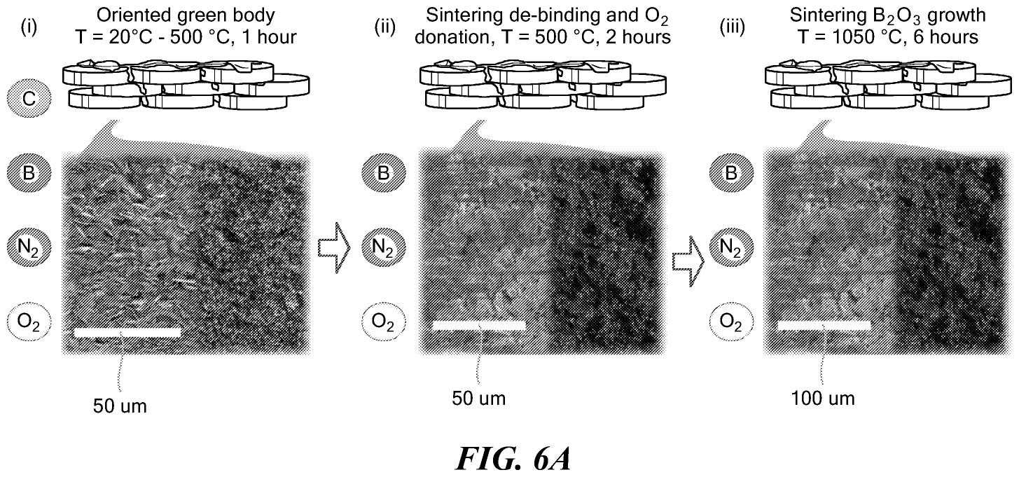

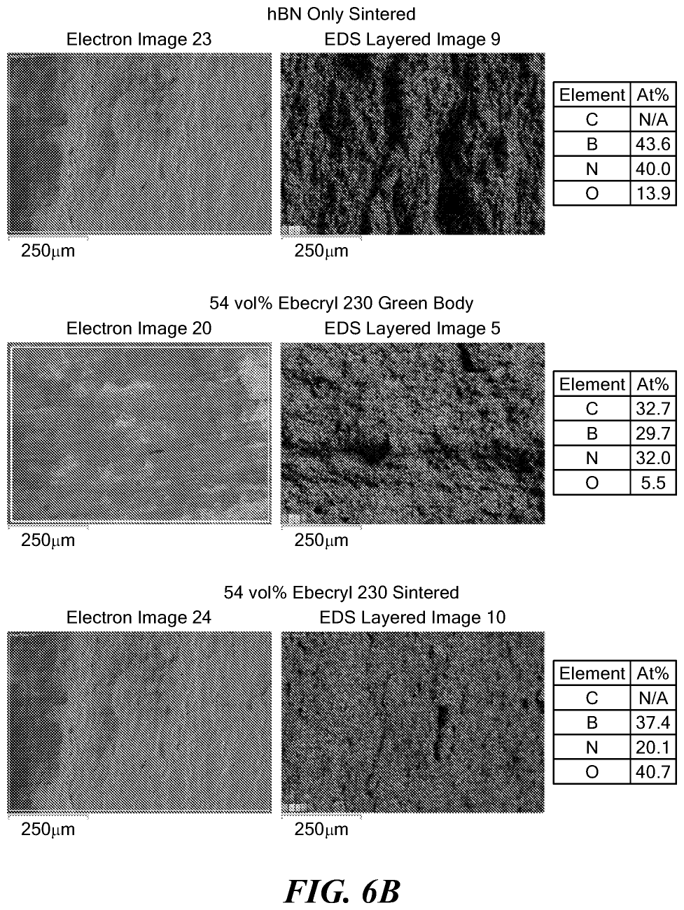

Referring to FIG. 6A, these polymeric green bodies then can be subjected to sintering at ambient pressure in oxygenated environments to grow a matrix of boron oxide that replaces the polymeric matrix and engulfs the hBN. To promote homogeneous growth of the boron oxide throughout the thickness of the green body, an oxygen-rich acrylate system can be selected. The material is placed in a sintering furnace and the temperature is raised to a first temperature (FIG. 6A, step (i)). The two-stage sintering process starts with a debinding (polymer burn-off) stage (step (ii)) that leaves behind trapped oxygen from the polymer, in some embodiments approximately 0.3 at %, (shown with the yellow EDX overlay on the SEM image inset) that has affinity for the boron and behaves as a seeding for the oxidation process. Next, the hBN is partially oxidized by increasing the sintering temperature to 1050° C. (FIG. 6A, step (iii)). The trapped oxygen enhances and homogenizes the oxidation kinetics of the hBN throughout the part (shown again with the EDX overlay) leading to a white all-ceramic part, described as a preform or blank. In some embodiments, the material can be sintered in atmospheric conditions for 6 hours at 1050° C. in dry air, to take advantage of the oxidation of hBN, creating approximately 40 vol % B₂O₃ acting as a secondary binder as the polymer is burnt from the system. FIG. 6B illustrates variations in atomic composition of elements carbon, boron, nitrogen, and oxygen for sintered hBN, a green body of 54 vol % Ebecryl 230, and sintered 54 vol % Ebecryl 230.

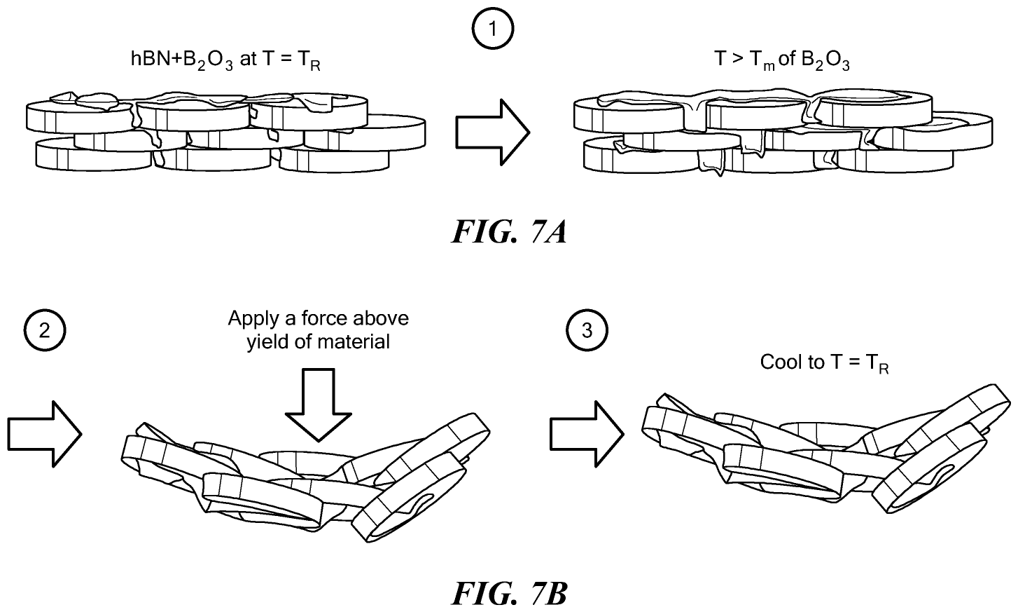

The orientation of hBN in the microstructure of the preform allows for in-plane flow during the thermoforming process. (FIGS. 7A and 7B) Thermoforming begins by first placing the preform on the negative mold surface of a two-part mold, heating the system to above the melting temperature Tₘ (450° C.) of the B₂O₃ and dwelling for a sufficient time to allow the sample and mold to reach equilibrium temperatures, in some embodiments 10 minutes. The boron oxide (B₂O₃) melts and the material behaves again as a viscous, particle-packed Bingham pseudoplastic exhibiting a yield stress that prevents flow until a suitable load is applied. Next, the mold compression load is applied for a suitable time (in some embodiments, at least 10 minutes or at least 15 minutes) to overcome the yield stress of the partially fluid all-ceramic, causing deformation. The mold is removed from the oven and cooled. The deformed ceramic can then be removed from the mold, resulting in a complex, thin, and lightweight part. Thus, these hBN ceramic materials can be thermoformed by applying sufficient heat, pressure, and dwell time. In some embodiments, heat can range from 500-700° C. In some embodiments, pressure can range from 50 kPa to 100 MPa. In some embodiments, pressure can range from 500 kPa to 5 MPa. In some embodiments, dwell time in the mold can be at least 10 minutes. In some embodiments, dwell time in the mold can be less than 10 minutes. In some embodiments, dwell time in the mold can be less than 5 minutes or less than 1 minute. In some embodiments, most of the time in the mold is spent bringing the mold and the preform up to a desired temperature. In some embodiment, parameter tolerances can be 20%, 10%, 5%, 1%, or 0.5%.

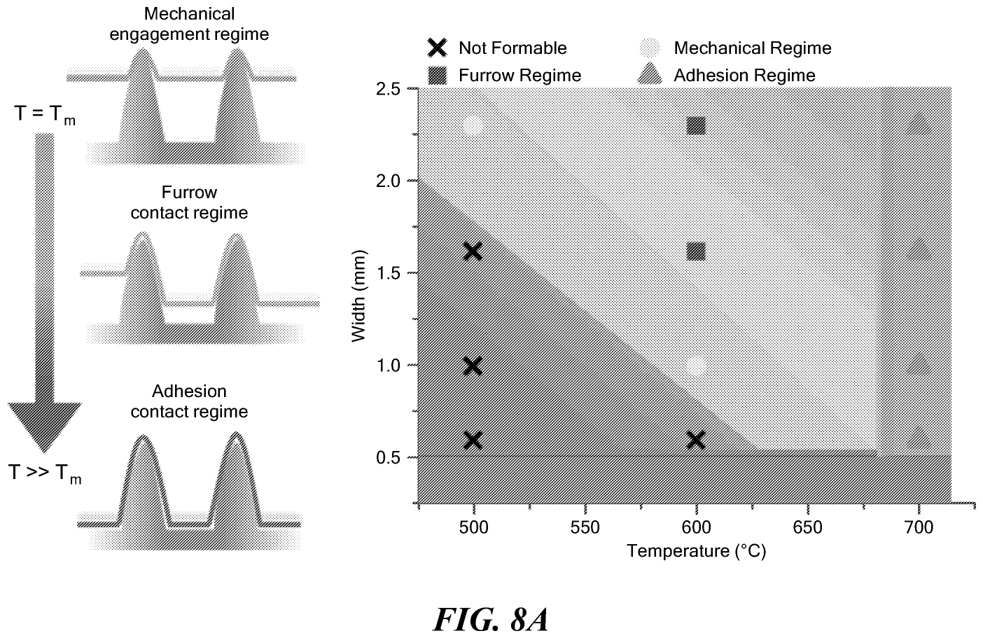

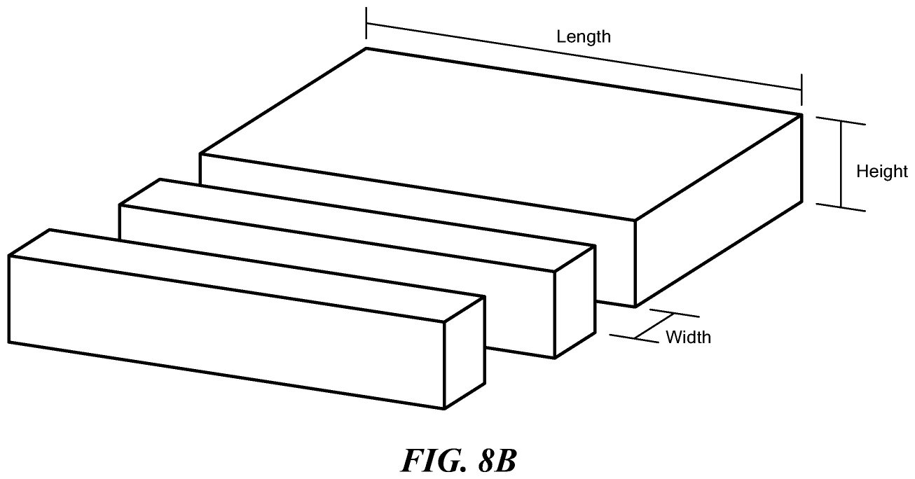

The formability of the preform can exhibit a dependence on temperature. Referring to FIGS. 8A, increasing the temperature during thermoforming can lead to formation of materials with finer feature sizes. At lower temperatures and greater viscosities, a material may fall within a mechanical engagement regime in which the material does not fully resolve the feature. As the temperature increases, finer features can be resolved with a transition to a furrow contact regime. As the temperature increases further, the material enters an adhesion regime with fully resolved features. Within the adhesion regime, the formed ceramic composite material can adhere to the surface of the mold and may require a high temperature mold release to remove formed parts. In some embodiments, from the feature sizes able to be molded based on different temperatures, a phase diagram (FIG. 8A) can assist with expected feature sizes at a given temperature. With the thermoforming regimes identified, molds can be designed, for example, in some embodiments, entirely in the adhesion contact regime. FIG. 8B is a schematic illustration of a mold identifying features of width, height, and length as used herein. Feature width is a width between mold features, where the feature of the mold creates an indented feature on the molded material. Feature height is a depth in which the material can be formed to the mold feature. Feature length is a dimension the spans the mold. In some embodiments, the mold can have a maximum draw ratio of about 1:1, wherein the draw ratio is defined as feature height to feature width.

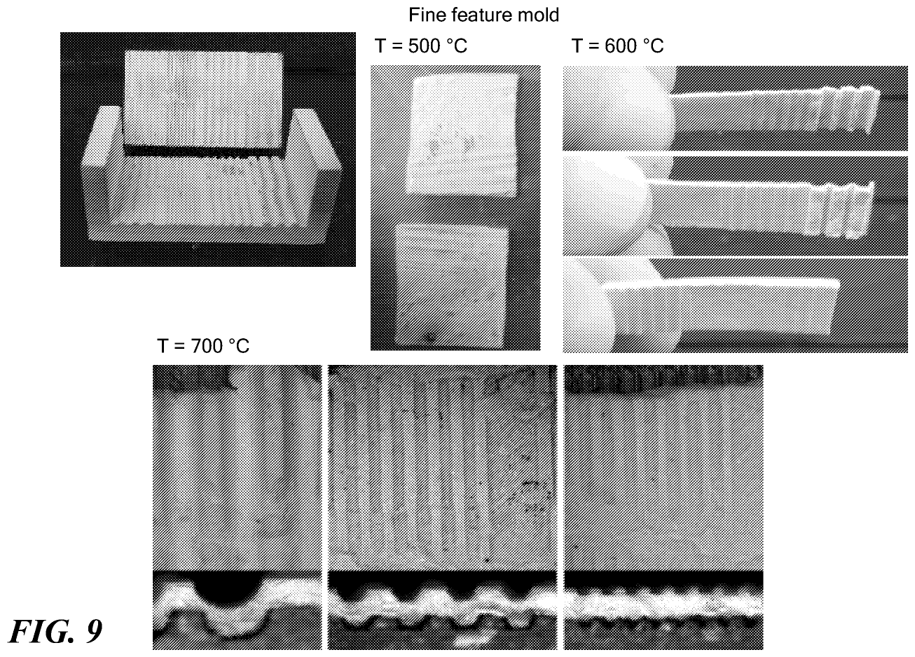

FIG. 9 illustrates a mold having fine feature sizes. The formation of finer features can require a lower viscosity, achievable by increasing the temperature. For example, the ceramic material having a liquid matrix of boron oxide shows reduced viscosity as the temperature increases above Tₘ of B₂O₃. Viscosity reduction for B₂O₃ at increasing temperature has been confirmed by Pei-Ching Li et-al, who derived an activation flow energy for B₂O₃ melts, Eᵥᵢₛ=(4.213E4)×1/T−22.15. As the temperature is increased, the energy necessary to induce flow is reduced. This fact can be exploited to increase the thermoforming resolution of the parts having finer features. At the lower temperature of 500° C. that is just above Tₘ for B₂O₃, thermoforming of the hBN ceramic material preforms is possible for feature widths above 2 mm, and is limited below 5 mm width features. Features below 2 mm at 500° C. do not resolve due to an inhibitive activation energy (characterized as the mechanical engagement regime). For 600° C., finer features can be resolved with the transition for the furrow contact regime moving down to feature sizes of 1.6 mm. Above 1.6 mm width feature size at 600° C., the material fully forms (characterized as the furrow contact regime). At 700° C., even more flow is enabled and features widths down to 0.6 mm are resolved (characterized as the adhesion regime). Within the adhesion regime, the formed all-ceramic can adhere to the surface of the mold and may require a high temperature mold release to remove formed parts. Increasing the temperature further is limited by the oxidation of the ceramic particles, e.g., BN above 1000° C. at longer times, and by the evaporation temperature of the oxide matrix, e.g., at 1375° C. for boron oxide, at shorter times. The oriented hBN microstructure plays a role in the forming process, due to the ability for aligned particles to flow past one another, where an isotopically aligned system would cause local particle jamming due to steric hindrances.

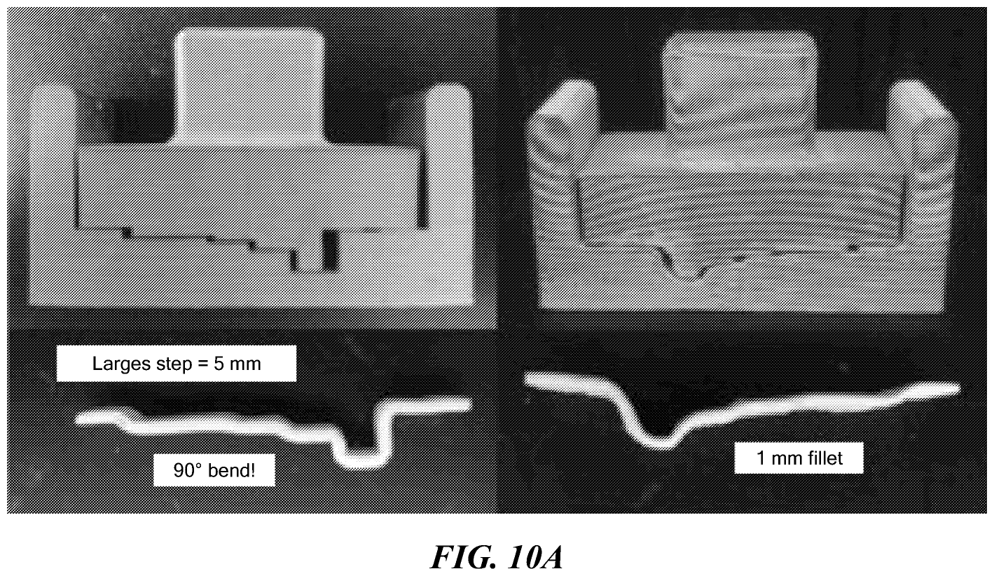

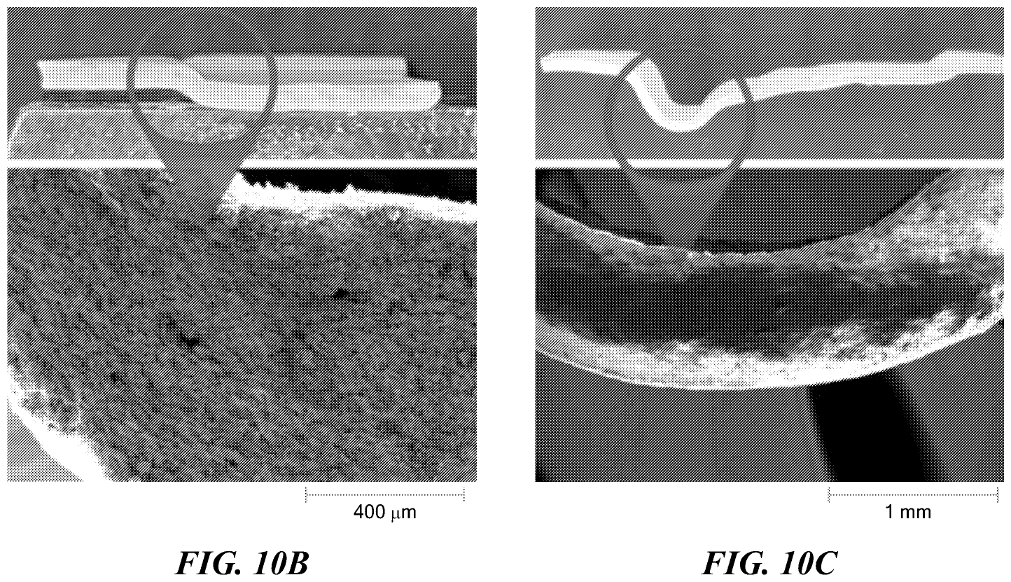

FIG. 10A illustrates two embodiments of molds with coarse features and a molded ceramic composite material molded in each mold at 500° C. The mold on the left has a number of 90° steps. The mold on the right has steps with a fillet with a 1 mm radius. In some embodiments, a coarse featured mold can be used to thermoform a ceramic preform with hBN platelet particles at the lower temperature of 500° C. with a 5.8 mm width feature size. In some embodiments, the preform can withstand a 90° bend with a 5 mm step without failure. In some embodiments, three-dimensional parts can be formed with a feature resolution of 200 μm.

FIG. 10B shows a fractured edge of a thermoformed heat sink formed in a large feature mold showing the particles formed to the deformation, and the aligned particles following the curvature. FIG. 10C shows an SEM of a sample deformed in a large feature mold, showing that the large deformation is smooth at the surface level, and showing no surface separation or cracking on the curved surface.

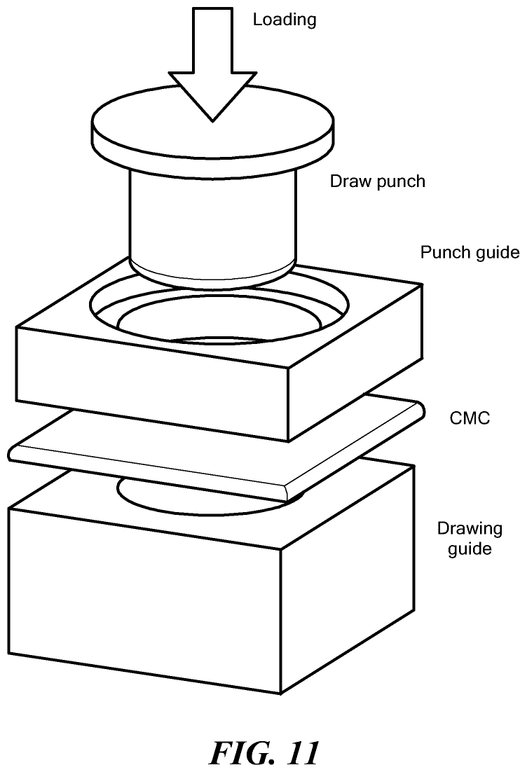

In some embodiments, a deep drawing mold can be employed. See FIG. 11. The mold can include a base or drawing guide providing a negative mold surface, a punch providing a positive mold surface, and a punch guide to align the punch with the base. In some embodiments, a maximum draw ratio of feature depth over width of 1:1 can be employed.

In some embodiments, a passive thermoforming technique can be employed, and in some embodiments, an active thermoforming technique can be employed, generally depending on the mold type and design. Passive thermoforming is where the mold is set with the ceramic composite material preform placed between the two mold halves and placed in the furnace at temperature. The weight of the top mold is enough load to form the ceramic, so no further loading is required. This technique can be suitable for a simple U-mold (described in Example 1) and the Raspberry Pi mold (described in Example 2). Active thermoforming is where a load is applied to the top mold to form the material. This can be useful when the top mold has a more complex surface geometry, where the mold may jam while sliding into the molded position. Active molding can be suitable for a course feature mold, a fine feature mold, a face mold (which can be considered a fine feature mold), and a deep drawing mold, as described herein. A high-temperature mold release (e.g., Hi-Temp 1800 Mold Release, Slide, Wheeling IL) can be applied to a mold to avoid adhesion and sample fracture during the removal of the part after forming is completed.

In some embodiments, the ceramic particles can be hexagonal boron nitride, boron oxide, hexagonal aluminum nitride, aluminum oxide, molybdenum disulfide, clay, cesium oxide, graphene, flake-like ferrites, calcium phosphate flakes, zirconia flakes, silica flakes. In some embodiments, the ceramic particles can be one or more of an oxide, a nitride, a carbide, a sulfide, and a fluoride in a flake form.

In some embodiments, the ceramic matrix can be boron oxide, silicon dioxide, glass flake, silver coated glass flake, or a lithium oxide-silica mixture. In some embodiments, the ceramic matrix can be a glassy or glassy-ceramic mixture having a softening phase or melting temperatures within a working service temperature range of a material forming the mold and below a melting or degradation temperature of the ceramic particles.

In some embodiments, the ceramic particle concentration in the molded ceramic composite material can be from about 30% to about 90% and the ceramic matrix concentration can be from about 10% to about 70%.

In some embodiments, a diameter of the ceramic particles in the molded ceramic composite material can be from about 1 μm to about 100 μm, or from about 5 μm to about 45 μm, and a thickness from about 3 to about 100 times less than the diameter. In some embodiments, the preform can have a thickness from about 0.05 mm to about 10 mm, or from about 0.1 mm to 3 mm. In some embodiments, the molded ceramic composite material can have a thickness from about 0.05 mm to about 10 mm, or from about 0.1 mm to 3 mm.

In some embodiments, the casting process can be scaled to a roll-to-roll or large-scale sheet fabrication, that includes a large format vibration platform. In some embodiments, the processes can form or be integrated into a production line for production of multiple parts. The thermoforming process also shows repeatability and reliability under different loading and temperature conditions. In some embodiment, tolerances for dimensions and other parameters described herein can be 20%, 10%, 5%, 1%, or 0.5%.

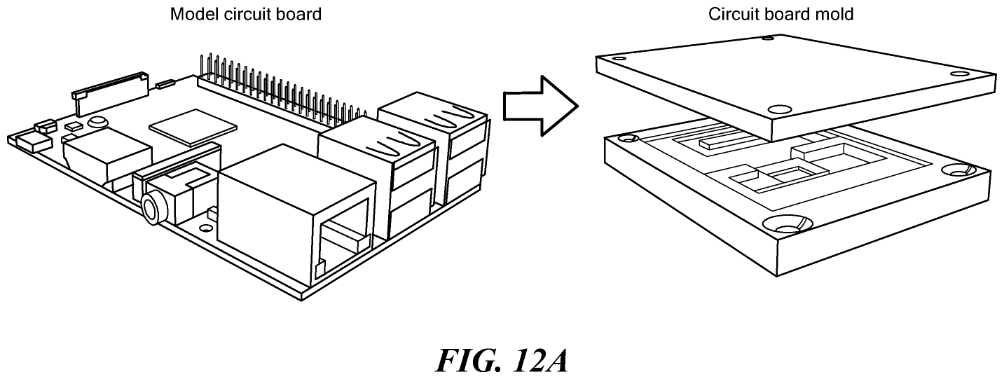

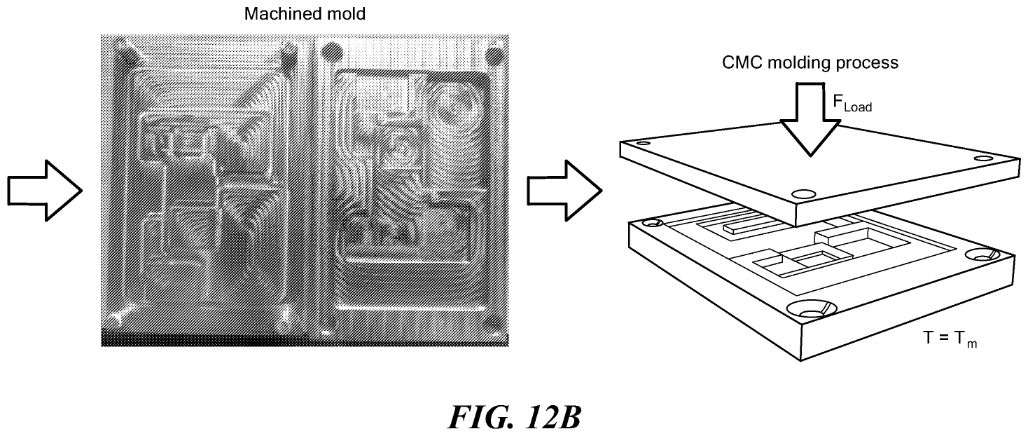

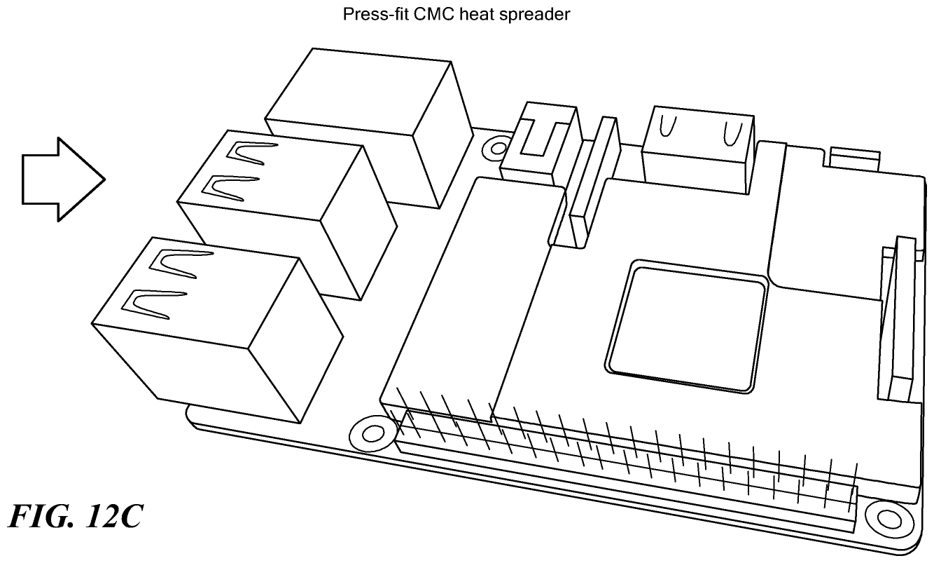

In some embodiments, the technology can provide a process to provide thermal management of devices, such as circuit boards, that generate heat. Referring to FIGS. 12A-12C, in one embodiment, a circuit board in need of thermal management is 3D scanned. From the scan, a positive and negative thermoforming mold is fabricated, for example, using an additive manufacturing process such as 3D printing. The mold can be made using other metal fabrication processes, including subtractive processes such as machining. The mold can be made from a metal or other material that can withstand the molding temperatures of the thermoforming process. The negative mold half has a geometric offset from the positive mold half that allows for the ceramic preform to be compressed between the two mold halves. A ceramic preform with an aligned microstructure fabricated as described herein is heated and compressed inside the mold as described herein. In some embodiments, the thermoformed ceramic structure can be coated in a water-protecting coating. Suitable coatings can include spray-on glasses, siloxane-based coatings, PTFE-sprays, dip-coating in epoxy or silicone, spray on epoxy or silicone, oil-based paints, and other commercially available barrier coatings. The structure is cooled and removed from the mold and then press-fit over the circuit board and can be used to spread heat generated by the electronic devices on the circuit board to serve as a thermal management solution. In some embodiments, a thermal management device employed as a heat sink can provide a heat transfer rate of 10° C./mm compared to a rate of 1° C./mm achieved by prior art metal heat sinks. This process can be repeated multiple times, in some cases, hundreds or thousands of times, to generate a heat management device for multiple circuit boards during a fabrication process.

The processes and materials described herein can provide a number of advantages over traditional ceramic manufacturing processes and prior art ceramic materials. The technology described herein can be used to produce dielectric ceramic materials that can be form-fitting to complex surfaces, that can withstand significant stress without failure, and that can be highly thermally conductive while electrically insulating. The technology can be used to form thin-walled, complex geometries of ceramic materials, rapidly, at low temperatures, and without the significant use of post-processing or machining techniques. No design tradeoffs are necessary due to part shrinkage or relaxation or post machining, because the preform is already fully sintered prior to the thermoforming steps. Traditional ceramic machining is costly due to the tooling and the required specialized expertise to carry out the machining. Prior art advanced manufacturing processes typically require near net shape processing, for example, to account for shrinkage or deformation during final sintering. Machining commonly introduces micro-cracking which hinders the formation of desired material properties.

The ceramic composite material can show improved properties such as thermal shock resistance and mechanical strength and toughness when compared to prior art materials such as commercially available hBN. The thermal management performance of the material as a heat sink or heat spreader can show improvement when compared to prior art metal heat sink and heat spreader devices.

The processes and devices described herein can provide thermal management for a variety of heat-producing applications with both suitable thermal conductivity and electrical resistivity. In contrast, prior art metal heat exchangers can provide good thermal conductivity, but poor electrical resistivity and are not a suitable solution for many electrical and radio frequency (RF) systems in which the potential exists for short circuit faults to arise. Prior art carbon fiber and graphite-filled composite materials exhibit thermal management behavior similar to metals. Prior art polymers and composites can provide improved electrical resistivity, but poor thermal conductivity.

The materials, products, and fabrication processes described herein can provide a variety of thermal management solutions and solutions for other applications that require complex geometries of thin-sheet ceramics. Devices and materials formed by the processes described herein can be used in a variety of products that require heat transfer, such as heat exchangers, cold plates, printed circuit boards, high performance CPUs, high-density electronic platforms, electronic chassis systems, RF devices, RF and phased antenna arrays, low-loss dielectric RF components, radomes, power inverters, solar cells, neutron shielding, high temperature heat shielding, heat shields for cube satellites, encapsulant, medical devices, and laminates having complex surface geometry.

The processes and products can be used in industries such as the aerospace, defense, renewable energy, clean energy, environmental, electrical vehicle (EV), transportation, and medical equipment industries. The processes can be integrated into other fabrication processes developed for designing and molding custom ceramic heat spreaders in complex geometries tailored specifically to any specific electronic device.

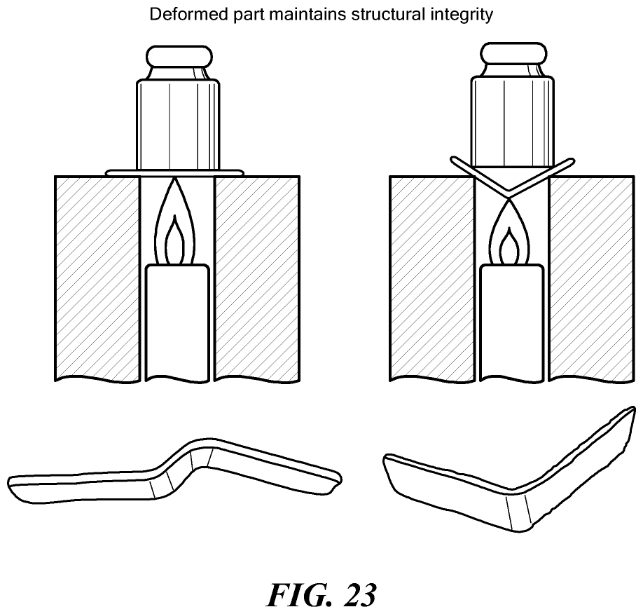

Initial observations of thermoforming were made during experiments comparing thermal shock potential of commercially purchased hBN sintered sheets (3 in×5 in× 1/16 in hBN sheets, McMaster-Carr), which exploded during application of a hot shock, and preforms of a ceramic composite material including aligned hBN particles, according to the technology described herein, which had no catastrophic reaction. Both materials, with different compositions, contained only hBN and B₂O₃. While doing a test with added load on top of the sample and a propane torch heating under the sample, the preform ceramic composite material began to deform and dropped onto the floor. The material was unharmed and permanently deformed. The same experiment was completed again to verify, and the material was deformed into a different geometry based on where the flame was positioned. (FIG. 23)

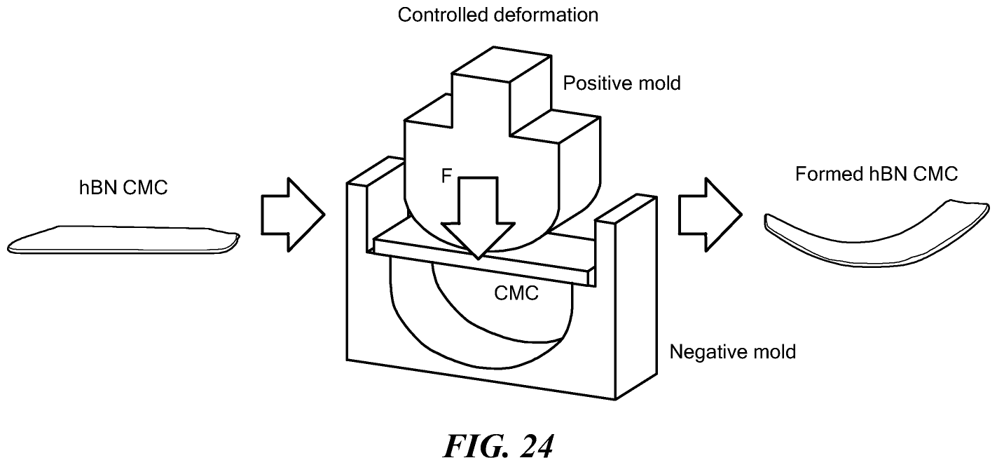

Next, a thermoforming processing method was tested and showed that, above the melting temperature of the matrix, the material was able to form into complex geometries without failure with a critical load. The processing method was tested by creating a U-shaped mold to verify that the molding process was repeatable and controllable (FIG. 24).

In one example, hexagonal boron nitride (hBN) was selected as the phononic ceramic particle and boron oxide as the ceramic matrix. The general process of creating preforms or coupons was divided into 3 steps: 1) material formulation, 2) curing and bake-out, 3) sintering. Concentrated ceramic slurries, 54 vol %, mixed with commercial hBN, an oxygen donating polymer, photoiniators, and diluents together to achieve a slurry rheology that only flowed under shear stresses. Here, the oxygen donating polymer, photoiniators and diluents were as follows, an acrylate resin (70 vol %, density of 1.15 g/cm³, EBECRYL 230, Allnex), Isobornyl Acrylate (30 vol %, density of 0.986 g/cm³, IBOA, Sigma-Aldrich) was added as a reactive diluent, and a 1:1 ratio of two photoiniators (0.1 vol %, 1-hydroxycyclohexyl phenyl ketone 99%, and Phynylbis (2,4,6-trimethylbenzyl) phosphine oxide 97%, Sigma-Aldrich). Finally, hBN, 12 μm platelets (54 vol %, PT-120 hBN, Momentive) was added in a volume concentration with respect to the resin. In this case an additional solvent was necessary to produce a uniform paste that flowed under shear conditions. Ethanol (8 vol %, Sigma-Aldrich) was added to further reduce the viscosity of the mixture, creating a slurry with a temporary loading reduction. The materials were then homogenized in a speed-mixer (DAC 150.1 FVZ-K, Flack Tek Inc) for 2 minutes at 1500 RPM. The final product yielded a slurry that behaved as a Hershel-Buckley fluid, in that it did not deform until shear stresses were applied.

To achieve exceptional particle orientation and percolation throughout the CMC, a vibration-assisted casting method as described herein was employed to align high volume fractions of hBN particles (60 vol %) in polymeric green bodies. These high loadings of hBN particles suspended in liquid photoresin behaved as Hershel-Buckley fluids, requiring shear in the form of vibration to effectively flow. Further, these dense particle suspensions were subjected to vibration energies during the tape casting process to further fluidize and shear align the hBN in-plane to a high degree (as described above with respect to FIGS. 1A-1C). After tape casting, the suspension was subjected to UV light to polymerize the photoresin, locking in the oriented hBN particles into a solid green body (as described above with respect to FIG. 1D).

These polymeric green bodies were then subjected to pressureless sintering in oxygenated environments to grow a matrix of boron oxide that replaced the polymeric matrix and engulfed the hBN. To promote homogeneous growth of the boron oxide throughout the thickness of the green body, an oxygen-rich acrylate system was selected. The two-stage sintering process (as described above) started with a debinding (polymer burn-off) stage that left behind approximately 0.3 at % trapped oxygen from the polymer that had affinity for the boron, and behaved as a seeding for the oxidation process. Next, the hBN was partially oxidized by increasing the sintering temperature to 1050° C. The trapped oxygen enhanced and homogenized the oxidation kinetics of the hBN throughout the par leading to a brilliantly white all-ceramic part, described herein as a preform or blank.

The orientation of hBN in the microstructure of the preform also allowed for in-plane flow during a thermoforming stamping process. Specifically, as the boron-based all-ceramic preform was placed in a negative mold and heated past 450° C., the boron oxide (B₂O₃) melted and the material behaved again as a viscous, particle-packed Bingham pseudoplastic exhibiting a yield stress that prevented flow until a critical load was applied. Thus, these hBN all-ceramics could be thermoformed by applying sufficient heat (500-700° C.), pressure (discussed below), and dwell time (above 10 minutes) as exemplified in the molding of an intricate all-ceramic human face using a metal 3D printed Inconel 625 mold (see FIG. 2A).

To understand the thermal properties, the in-plane and through-plane thermal conductivity was measured. Due to the shear alignment of the hBN particles during the tape casting, a higher in-plane thermal conductivity was expected relative to the through-plane. Through-plane thermal conductivity was characterized with ASTM E1461 and found to be 3.52 +/−0.67 W/mK at room temperature. In-plane thermal conductivity was characterized using the Angstron method (see Section 2.4, Materials and Methods) and found to be 12.8 W/mK at room temperature. These values were both well below the theoretical conductivities of pure hexagonal boron nitride highlighting the thermal resistance that the boron oxide matrix provided to detract from the overall conductivity. Nonetheless, these thermal conductivity values put these boron nitride based all-ceramics in a useful space for dielectrics that can conduct heat especially when density and high resolution formability is important to the application space

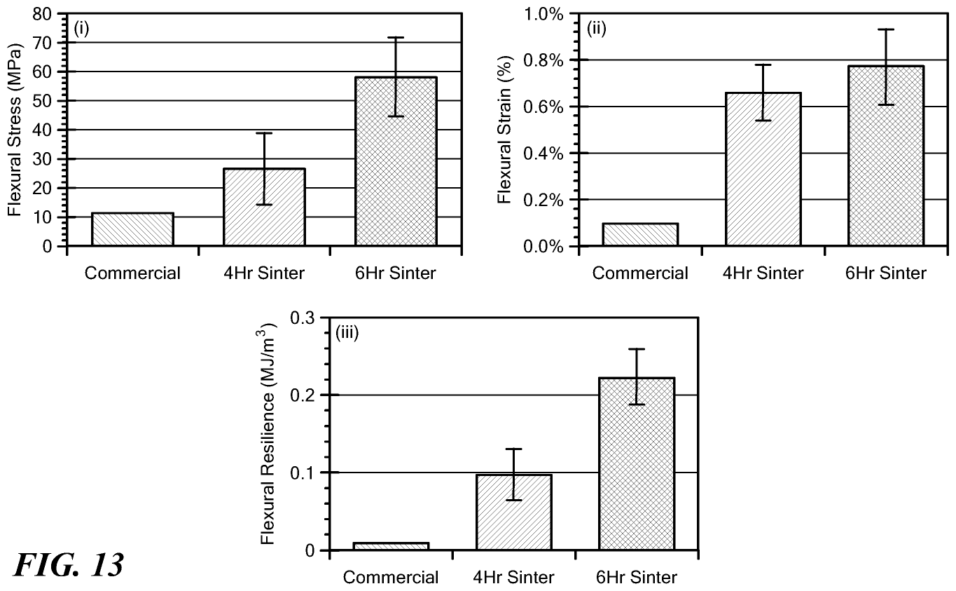

To quantify the mechanical robustness of the boron nitride based all-ceramic preforms, sintered specimens were subjected to 3-pt bend flexural characterization (see Section 2.4, Materials and Methods). Sintering dwell times of both 4 hours and 6 hours were trialed resulting in increasingly robust mechanical properties (FIG. 13). The 6 hour sintered samples resulted in flexural strength of σ_{flex}=58.88+/−13.72 MPa, the flexural strain at break of ∈_{flex}=0.78+/−0.17%, and the flexural resilience of 0.22+/−0.037 MJ/m³, which was measured by using Uᵣ=1/2·σ_{flex}·∈_{flex}. As a benchmark, a commercial sample (McMaster Carr) of a hot-pressed boron nitride based all-ceramic marketed for thermal management was purchased and tested in identical fashion, exhibiting significantly lower flexural strength, strain at break, and resiliency. Notably, the commercial sample lacked an oriented microstructure and was found to have no thermoforming capabilities. Relative to traditional ceramic materials like the commercial sample, the boron nitride based ceramic material tested in this example exhibited impressive resiliency. This is likely derived from the oriented nacre-like microstructure underlying these materials. Throughout the rest of this example, the 6 hour sintering dwell time was used.

The composition of the boron nitride based ceramic composite materials manufactured and considered herein were expected to be hBN and B₂O₃ with decent amounts of porosity due to pressureless sintering and non-optimized manufacturing at this stage. To verify these expectations, a modified Archimedes method coupled with XRD was conducted to validate the composition (see Section 2.4, Materials and Methods). Manufactured ceramic composite materials exhibited an average density of 1.42+/−0.10 g/cm³ and a balanced hBN and B₂O₃ content of 49.8 vol % and 50.2 vol %, respectively. The samples had a high porosity content calculated to be 37.9 vol %. Nonetheless, these sample compositions resulted in preform “blanks” that exhibited significant mechanical properties as described above and could be effectively thermoformed into intricate thin geometries.

### Ceramic Matrix Composite Thermoforming and Current Feature Resolution

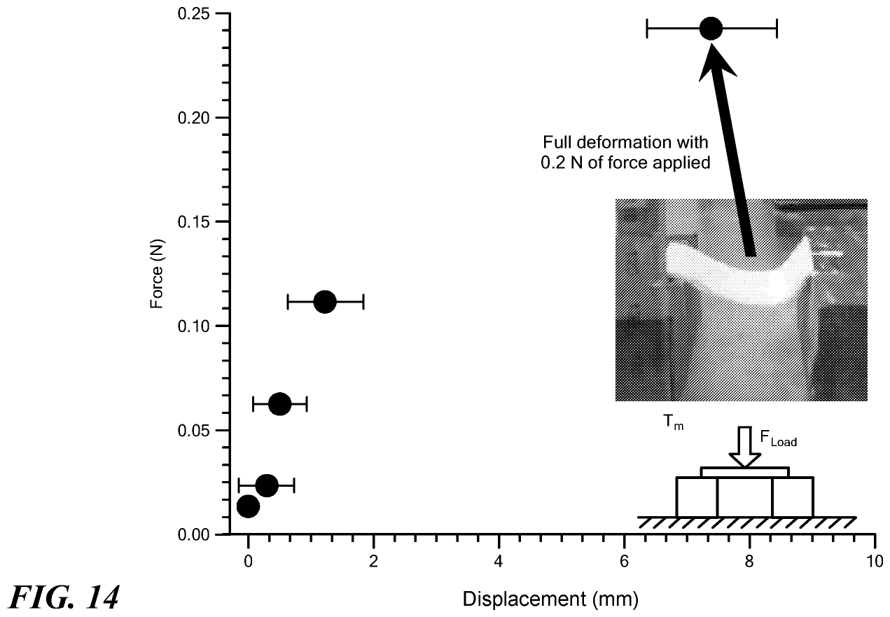

To explore the processing structure relationships within thermoformable ceramic composite materials, the yield strength of these preforms at 500° C. was characterized in a simply supported configuration shown in (FIG. 14). Despite the temperature being above the melting temperature, Tₘ, of B₂O₃ (Tₘ=450° C.), there was no flow under 0.01 N of force. As the loading was increased, the sample deformed with a maximum deflection in the simply supported configuration of 0.2 N of force. This behavior corroborates the hypothesis that these boron-based ceramic composite materials behaved as Bingham plastics due to their microstructure and composition of a fluid-like matrix and solid loading near 50 vol %, a direct analog to concentrated slurries.

To understand the temperature dependence of the formability of the preforms, a fine feature mold (such as that described with respect to FIG. 9) was tested across elevated temperatures to establish the contact regimes (FIG. 8B) that correspond to flow characteristics. At these elevated temperatures, the ceramic composite material had a liquid matrix of boron oxide that showed reduced viscosity as the temperature increased above Tₘ of B₂O₃. At the lower temperature of 500° C. that was just above Tₘ for B₂O₃, thermoforming of the hBN ceramic composite material preforms was only possible for feature widths above 2 mm, and was limited below 5 mm width features. Features below 2 mm at 500° C. did not resolve due to an inhibitive activation energy (characterized as the mechanical engagement regime). For 600° C., finer features could be resolved with the transition for the furrow contact regime moving down to feature sizes of 1.6 mm. Above 1.6 mm width feature size at 600° C., the material fully formed (characterized as the furrow contact regime). At 700° C., even more flow was enabled and features widths down to 0.6 mm were resolved (characterized as the adhesion regime). Within the adhesion regime, the formed ceramic composite material adhered to the surface of the mold, requiring a high temperature mold release to remove formed parts. Increasing the temperature further was limited by the oxidation of BN above 1000° C. at longer times and by the evaporation temperature of the oxide matrix at 1375° C. at shorter times. It is believed that the oriented hBN microstructure plays a role in the forming process, due to the ability for aligned particles to flow past one-another, where an isotopically aligned system would cause local particle jamming due to steric hindrances. The step mold shown in FIG. 10 was successfully used to thermoform a ceramic composite material preform at the lower temperature of 500° C. with a 5.8 mm width feature size. Here, the preform was able withstand a 90° bend with a 5 mm step without failure. The thermoforming process showed repeatability and reliability under different loading and temperature conditions.

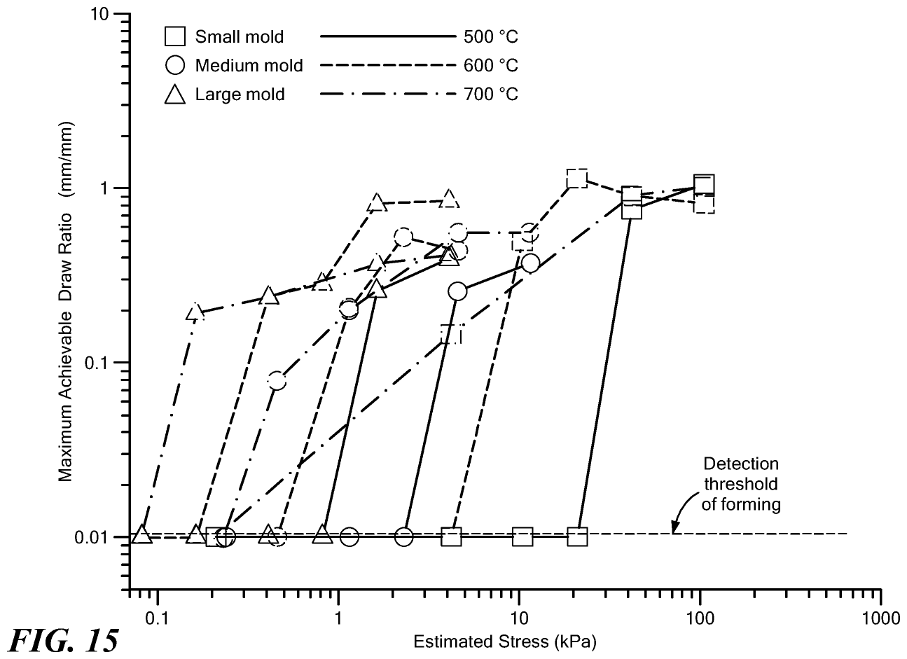

To further characterize the capabilities of this manufacturing process, the success of various draw ratios (defined as a feature depth over width) was characterized in a systematic molding study using deep drawing molds such as in FIG. 11. The molds were designed with the maximum draw ratio that varied based on sample size with the maximum pin lengths ranging from 1.6 mm to 6.93 mm and the maximum draw ratio possible was 2.32 for each mold size. The results revealed the dependences between the maximum draw ratio withstood by the preforms prior to tearing across temperature and mold size (FIG. 15). A clear upper limit around a draw ratio of 1.0 was observed independent of temperatures and mold size. This limit also represented the threshold of deep drawing and was likely a function of sheet thickness, mold preparation, and mold process that can be further optimized to find the limits of this process. Lower molding temperatures required higher pressures to thermoform which is consistent with the activation energy for flow in molten B₂O₃ matrices. Above the maximum achievable draw ratio, tearing of the preform was observed. The higher temperature of 700° C. allowed for thermoforming under smaller compression stresses but generally resulted in a lower viscosity preform that was more susceptible to tearing. Remarkably, draw ratios over 1.0 were demonstrated allowing the molding outcomes using this method to be classified as deep drawn. Deep drawing is an aggressive regime of thermoforming that presents significant challenge even to certain thermoplastic polymers and metals.

### Thermal Management Application Performance Testing

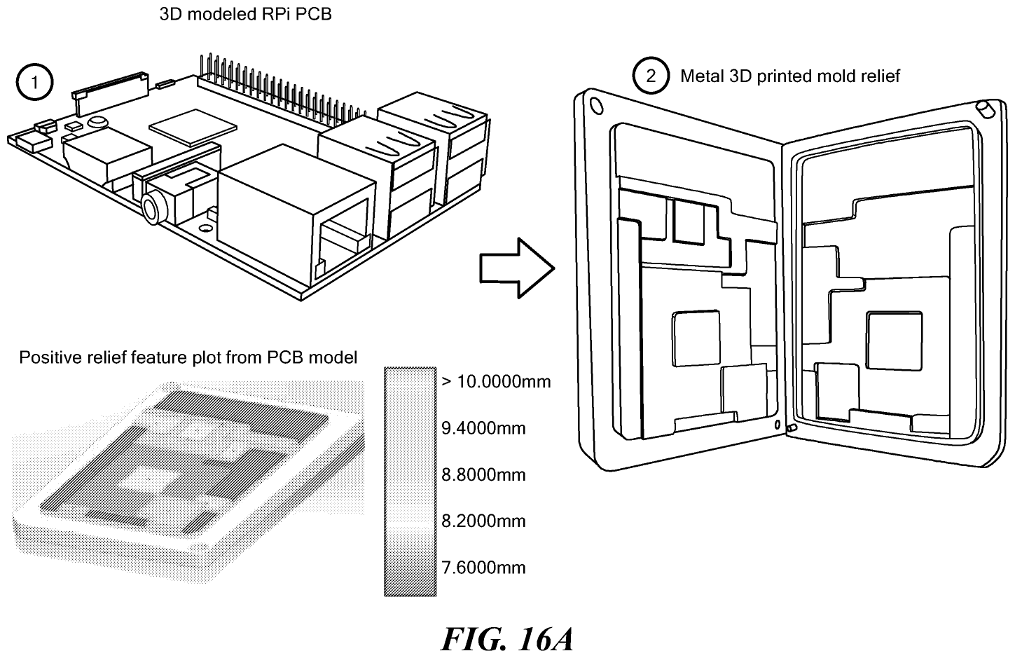

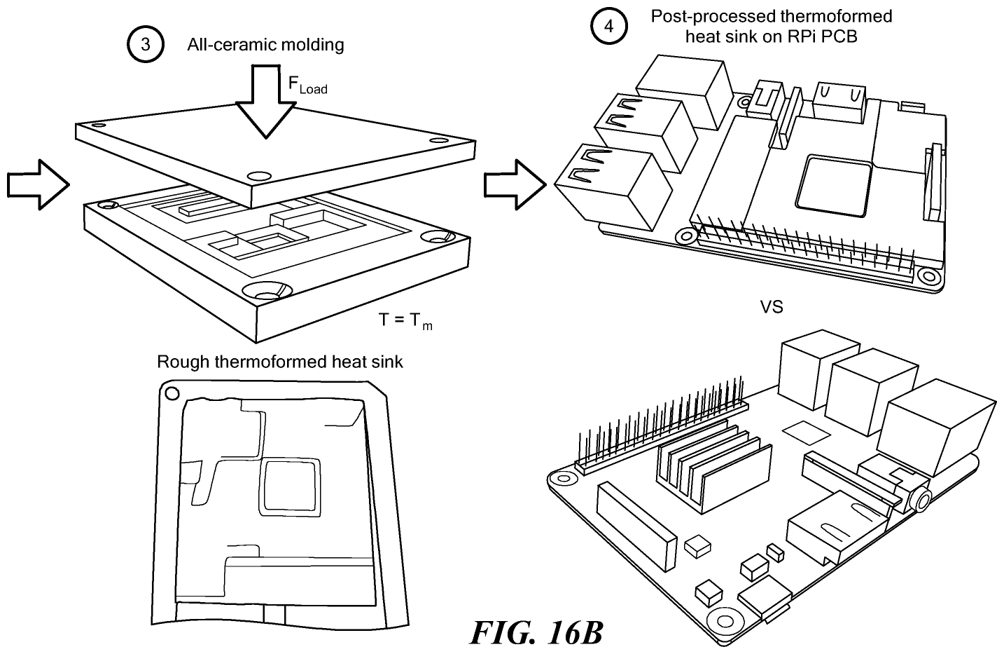

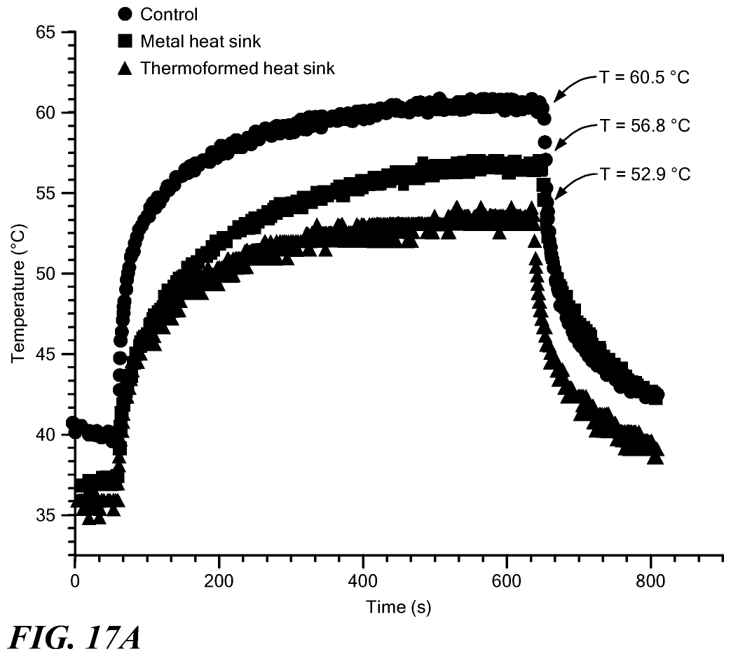

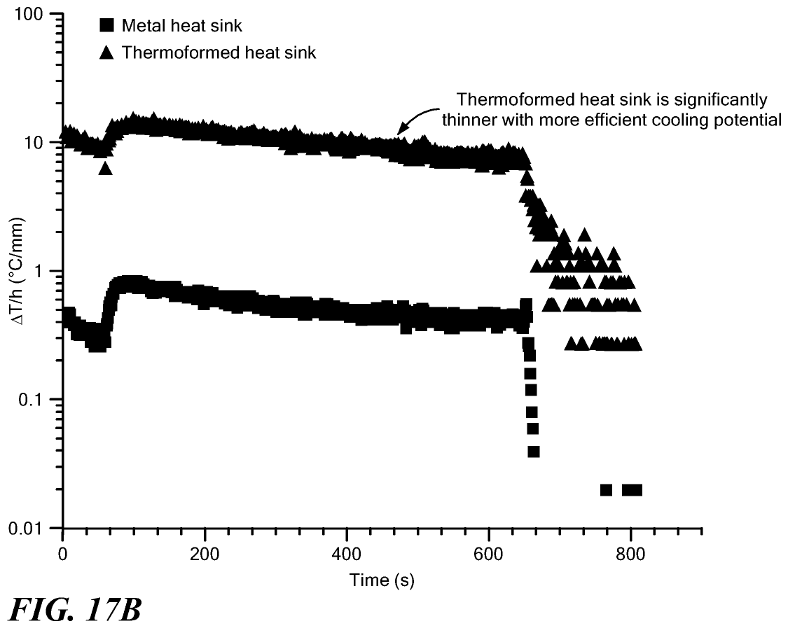

The application of thermoforming of ceramic composite materials to thermal management applications was demonstrated through in situ performance testing. Specifically, the entire thermoforming process described herein was applied to manufacture quick turn all-ceramic heat spreaders for bespoke printed circuit boards (PCBs). Referring to FIGS. 16A and 16B, this process was explored using a Raspberry Pi (RPi) circuit board as the PCB that featured internal thermocouples to track operating temperatures. First, a mold was designed from a 3D CAD model of the PCB and metal 3D printed from Inconel 625. A phononic ceramic composite material preform was thermoformed in the adhesion contact regime (500° C. for these feature sizes). After light post-processing, the thermoformed material was press-fit over the PCB and set using a small amount of thermal paste to minimize the thermal impedance of the connection and allow robustness for device handling. To assess performance, the PCB was subjected to 10 minutes of fully throttling the processor chip to reach a maximum steady-state temperature, using a custom program (see Section 2.4, Materials and Methods). Comparisons were conducted between the as-received PCB, the PCB with an additionally offered metal heat sink package for cooling, and the thermoformed ceramic composite material heat spreader described herein. The metal heat sink package offered by the supplier featured a parallel fin aluminum heat sink that required a 9.07 mm thick spatial envelope to fit, as compared with the 0.68 mm thick ceramic composite material heat spreader. During equivalent tests, the internal thermocouple was used to assess the internal temperature of the processor chip, which showed that the ceramic composite material heat spreader (maximum temperature of 52.9° C.) out-performed the larger aluminum heat sink package (maximum temperature of 56.8° C.), with both providing cooling advantage over the as-received system (maximum temperature of 60.5° C.) (FIG. 17A). Additionally, the surface temperature of the PCB in all three cases was measured using a FLIR camera and showed similar results. To emphasize the performance for the thin, conformal all-ceramic heat spreader, the cooling effect for each thermal management solution relative to the as-received system normalized by the thickness of the required geometric envelope (units of ° C./mm) was plotted (FIG. 17B). When the cooling effectiveness (measured by the reduction in temperature compared to the as-received control, AT) of the ceramic composite material heat spreader and metal heat sink were normalized by the thickness of the thermal management solution, the all-ceramic thermoformed heat spreader outperformed the metal heatsink by over a decade on the semi-log plot scale. In cases where the geometric envelope for thermal management solutions needs to be minimized, this normalization indicates that the thermoformed all-ceramic heat spreaders outperformed the current prior art metal heat sinks by a full decade on a semi-log performance plot. Further, these ceramic composite material heat sinks are made from strong dielectrics and could be used in more intimate contact against electrical connectors in the PCB to help move heat more effectively.

### Material Formulation

The general process of creating preforms or coupons can be divided into 3 steps: 1) material formulation, 2) curing and bake-out, 3) sintering. Concentrated ceramic slurries, 54 vol %, were mixed together with commercial hBN, an oxygen donating polymer, photoiniators, and diluents to achieve a slurry rheology that only flows under shear stresses. In this example, the oxygen donating polymer, photoiniators and diluents were as follows: an acrylate resin (70 vol %, density of 1.15 g/cm³, EBECRYL 230, Allnex), Isobornyl Acrylate (30 vol %, density of 0.986 g/cm³, IBOA, Sigma-Aldrich) was added as a reactive diluent, and a 1:1 ratio of two photoiniators (0.1 vol %, 1-hydroxycyclohexyl phenyl ketone 99%, and Phynylbis (2,4,6-trimethylbenzyl) phosphine oxide 97%, Sigma-Aldrich). Finally, hBN, 12 μm platelets (54 vol %, PT-120 hBN, Momentive) was added in a volume concentration with respect to the resin. In this case an additional solvent was necessary to produce a uniform paste that flows under shear conditions. Ethanol (8 vol %, Sigma-Aldrich) was added to further reduce the viscosity of the mixture, creating a slurry with a temporary loading reduction. The materials were then homogenized in a speed-mixer (DAC 150.1 FVZ-K, FlackTek Inc) for 2 minutes at 1500 RPM. The final product yielded a slurry that behaved as a Hershel-Buckley fluid, in that it did not deform until shear stresses were applied.

### Preform Fabrication Process

The preform fabrication was completed by applying vibrational and surface shear forces from a casting blade to spread a thin layer (200 μm) for photopolymerization. This process was repeated 6 times until approximately 1.2 mm was reached. The vibration-tape casting system used vibration to reduce the viscosity, fluidizing the material system. The vibration of the modified stage was produced by a single axis vibrator (JT-51B Vibrator, Jintai), and was initially increased until fluid motion was observed, then that level of vibration was set for the remainder of the testing. Once the slurry was fluidized under vibrational shear, a casting blade thinned the material to a sheet with a user-defined thickness, the vibration was then turned off and then the binder was cured by UV radiation exposure using a 405 nm DLP UV-projector (PRO4500, Wintech Digital System Technology Corp.) (See FIGS. 1A-1D). The limitation of this process was that the layer thickness could go below 100 μm due to delamination during the sintering process, and could not be more than 20× the particle size to get reasonable particle alignment. Additionally, a single layer sample could be processed using a translucent sheet; here a 0.25″ thick piece of glass was used, to press and spread the fluid during vibration into a planar mold. Once the material was spread, the material was then exposed to a 405 nm UV lamp, placed on top of the glass to create a green body. The pressing coupled with vibration created a squeeze-flow type environment, where the streamlines that formed perpendicular to the force of the pressing-plate aligned the particles using the same shear force mechanism as the casting blade, creating a shear flow that forced the particles into a preferred direction. The negative planar mold was made of glass or clear acrylic to enable light to reach the sides of the sample while curing. Negative space occupied no more than an 80 mm×60 mm rectangle, such that all material fit under the curing light, where the top was a square sheet of 0.25 in glass that was used to press the material into the negative space while vibration was on. The limitation in this process was the curing time. For example, the particle size dependence with a layer thickness of 1-1.5 mm composed of 12 μm hBN particles, were cured for at least 60 minutes, where a layer from the DLP printing process took 1-2 minutes per layer depending on the layer thickness. Once cured, the ethanol was then baked out of the sample by placing it in a 60° C. oven for at least two hours, stiffening the green-body further as the ethanol evaporated. These samples were then ready to be sintered. The sintering profile was as follows, ramp to 60° C. in 1 hour, dwell for 20 min, ramp to 500° C. in 1 hour, dwell for 2 hours to burn off resin, ramp to 1050° C. in 1 hour and dwell for 6 hours to allow for B₂O₃ to form the secondary binder. The samples were then allowed to cool naturally down to room temperature for handling. Of note, in both methods dimensioning the casted sheet can take into account shrinkage due to polymer burn off during sintering. Shrinkage was tested tracking the dimensional changes of rectangular samples in the green state versus in the post-sintered state and found to be 12.4+/−. 37% in the X axis, 11.4+/−3.85% in the Y axis, and 19.6+/−3.21% in the Z-axis (through-plane). The shrinkage was anisotropic likely due to the in-plane orientation of the hBN particles that reduced in-plane shrinkage. In this example, shrinkage was addressed by scaling up green body dimensions by these corresponding shrinkage percentages, such that post-sintering the parts exhibited the desired dimensions. Further, limiting adhesion between the cured coupon and the surfaces was useful to avoid tearing when removing the sample. This was accomplished by placing Kapton tape on the bottom casting surface for both processes, and for the press-casting process, the glass sheet was coated using mold release.

### Mold Design and Fabrication

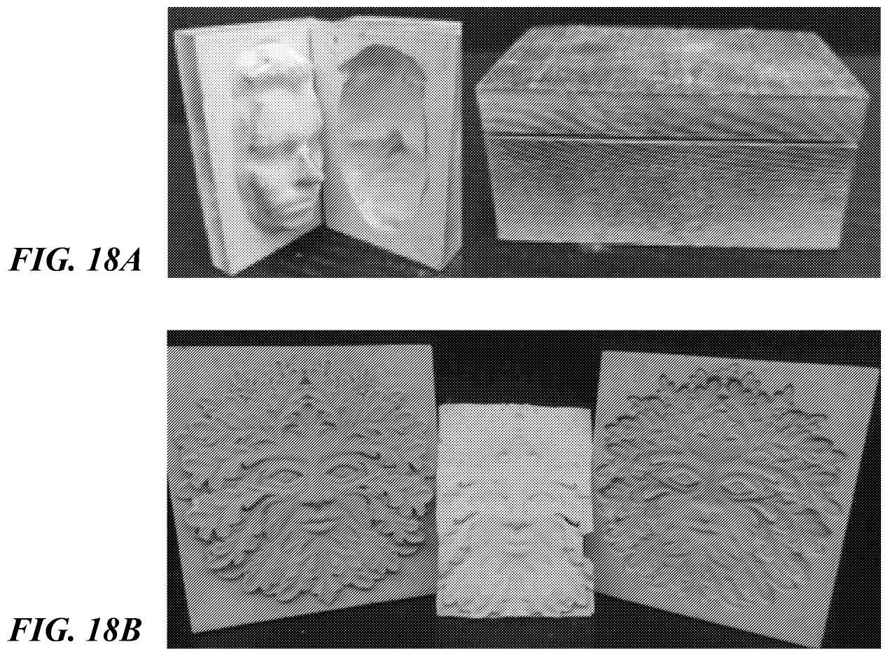

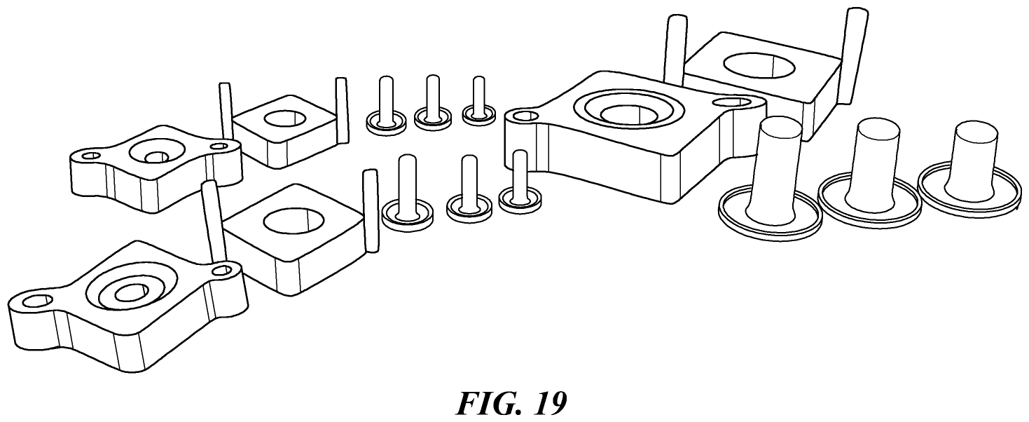

Molds were designed to demonstrate bending, stretching, and conforming capabilities and the resolution of the process and materials. Each mold was designed in SolidWORKS (Dassault Systems, France) and was then fabricated using Inconel 625 filament with a Markforged metal 3D printing and sintering system (Markforged, MA). Inconel was selected to sustain repeated heating and cooling cycles during the thermoforming process. Five different types of mold were prepared: 1) a course feature mold (FIG. 10) that helped define the bending angles and large step features that are possible at the lowest forming temperature, 500° C.; 2) a fine feature mold (FIG. 9) to study the different flow regimes as temperature was increased from 500° C. to 700° C., with steps of 100° C.; 3) human face molds (FIGS. 2A, 18A, 18B) to show multi-feature resolution on a single sheet; 4) several deep drawing molds (FIG. 19) to perform the traditional deep drawing process used in metals, and validate the current thermal forming resolution possible; and 5) a Raspberry Pi mold (FIG. 16A) to study the performance of the thermoformed material as an all-ceramic form-fitting heat spreader.

### Thermoforming Process

Molds were placed in a box furnace (KSL 1200X, MTI Corp.) after the oven was heated to the desired temperature (500° C., 600° C., and 700° C.). Boron oxide has a melting temperature of 450° C. The temperature was heated 50° C. above the melting temperature to induce a reduced viscosity in the melt, allowing forming; prior to 500° C., no forming was observed to be possible. To provide finer features the temperature increase was required, but nothing above 700° C. was necessary to achieve fine features with the current molds. Once the oven was heated, the mold and sample were inserted into the oven and allowed to equilibrate for 10 minutes. After the dwell time, the oven was opened and the top of the mold was pressed to induce forming. The mold was then taken out of the oven and the part was removed from the mold.

### Material Yield Characterization at Molding Temperature

To get a basic understanding of the force necessary to induce molding, yield force was characterized. This was completed with the same heating process at 500° C., except a rectangular envelope was placed on top of two steel blocks, with a precision mass load acting as the loading force. The masses were increased from 1 g-20 g. Increasing masses were placed on top of the sample and allowed to soak at 500° C. for 10 minutes. After the soak time, the door was opened and pictures were taken with a ruler on the side of the oven for post processing in ImageJ. Each image was then processed to measure the bending of the sample. In all cases, the sample was continually loaded, imaged, and measured with incremental masses for all 3 samples until the sample fully deformed under the load condition.

### Three-Point-Bending Test

Mechanics were tested using a three-point-bending setup (Instron, Norwood, MA). The fixture span was 10 mm long with a pointed tip jig. The extension rate was set at 10 mm/min with a 500 N loading cell. All mechanically tested parts were at least 40 mm×12.5 mm×1 mm (1, w, t). All samples were lightly sanded with 220 grit sandpaper to smooth the surface prior to all mechanical testing to eliminate minor surface deficiencies from the printing process.

### Thermal Conductivity Measurements

To measure the thermal conductivity, different methods were used for in-plane and through-plane properties. In both cases, differential scanning calorimetry (Netzsch DSC 204) was used to measure the specific heat capacity, based on ASTM E1269. For through-plane thermal conductivity, the through-plane thermal diffusivity was measured based on ASTM E1461 for the laser flash method (using Netzsch LFA 447, conducted by Netzsch). The samples were 10 mm in diameter and 0.9 mm thick. For in-plane thermal conductivity, the in-plane thermal diffusivity was obtained through the Angstrom method. Briefly, the sample was clamped between two coupled heater wires connected to a sinusoidally oscillating DC power source at 0.002 Hz with an amplitude of 2.1 W. 1 mm of the opposite end of the sample rested on an aluminum billet. Thermocouples were placed at distances of 5 mm and 10.8 mm from the heat source, and the setup was enclosed to minimize convective variation. After measurement for approximately 3 hours the temperature profiles were fit to sine waves and the corresponding amplitudes and phase shifts were extracted. The in-plane diffusivity was calculated as α=L² (2 Δt In (M/N)), where L is the distance between the thermocouples, Δt is the time shift between the temperature profiles, and M and N are the amplitudes measured by the thermocouples respectively nearer and farther from the heat source. Through this analysis an in-plane thermal diffusivity of 0.091 cm²/s and associated in-plane thermal conductivity of 12.8 W/mK was obtained for the boron nitride based ceramic composite materials described herein. Additionally, this method was confirmed to accurately measure known samples (e.g., copper, borosilicate glass).

Compositional Analysis of Boron Nitride based All-Ceramics

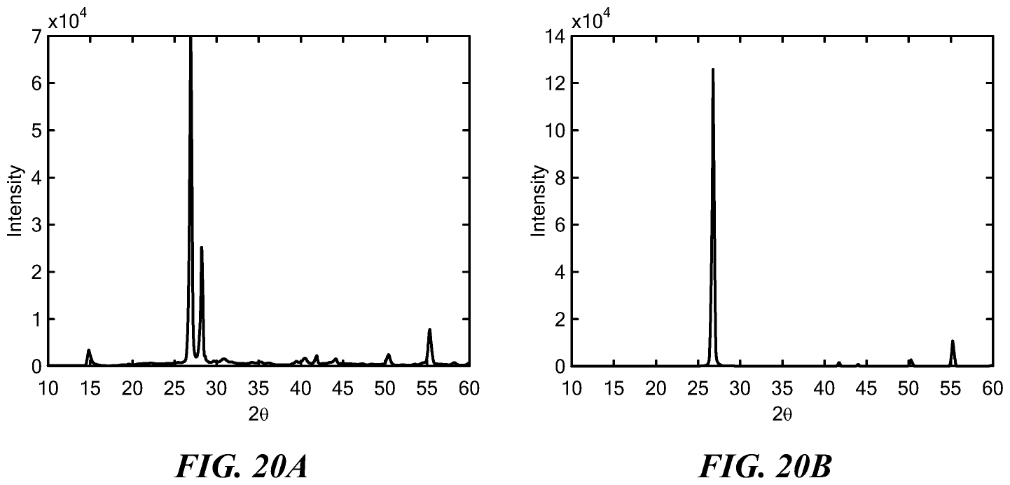

To measure the composition of all-ceramics, a modified Archimedes method was conducted coupled with XRD to validate the composition. The composition of three rectangular block samples was measured by measuring volume with calipers and mass with a precision balance (ATY224, Shimadzu). The B₂O₃ of the samples was dissolved to completion in sufficient hot water (60° C.) to stay below the solubility limit, leaving insoluble hBN particles in the aqueous boria solution and filtered the slurry through a 0.45 μm nylon filter to remove the hBN particles. The pre-weighed filter was dried overnight in a 60° C. oven and weighed to determine the mass of hBN. The removal of the B₂O₃ was confirmed by small angle x-ray diffraction (SAXS) measurements (ULTIMA IV, Rigaku), (FIGS. 20A and 20B). The measured mass of the hBN and original sample masses provided the mass percentages of hBN and B₂O₃ in each sample. Using the densities of 2.1 g/cm3 and 2.46 g/cm³, for hBN and B₂O₃, respectively, allowed for calculation of the relative volume percentages. Finally, knowing the relative volume percentages of hBN and B₂O₃ coupled with the original part density allowed for calculations of the volume percentages of air.

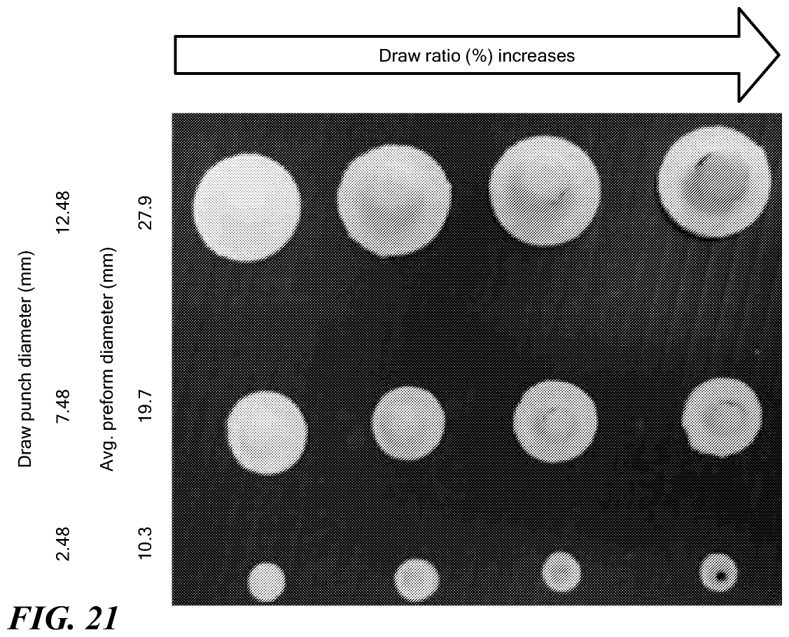

Deep Drawing Method Similar to the yield characterization method above, the deep drawing was completed by heating the oven to 500° C., 600° C., and 700° C. to test the drawing characteristics of the material using specific molds designed for the process (FIG. 19). To induce deformation, precision masses (20 g, 50 g, 100 g, 200 g, and 500 g) were used to progress the drawing process. The mold assembly with drawing punch and preform were loaded into the oven at temperature and allowed to soak for 10 minutes before the mass was applied. After 10 minutes, the door was opened and the mass was placed on top of the drawing punch for approximately 10 seconds before removal. The above method was completed to control the flow process by loading and to achieve the highest possible drawing depth possible under a selected load. After the mass was removed, the mold assembly was removed from the oven, the sample was measured and placed back into the mold for further drawing. The process was repeated and loading increased until tearing occurred. At this point, the sample was considered to have failed. Examples of the drawn and torn samples can be referenced in FIG. 21. Above the drawing threshold, initial surface tearing occurred at the curved edge. Once pushed further, the top of the sample sheared off at that point. Further, once the top was removed, it can be observed that the walls of the part thinned, visible in the small diameter formed sample. This shows that material extrusion was taking place, as opposed to pure drawing. This was also evident because the material diameter did not change in this deep drawing process.

More particularly, deep drawing is a broad category encompassing many different molds, so these were designed to allow flexibility in testing in case one mold design proved more successful than another. To that end, the molds were designed to test permutations of three geometric parameters: diameter size, punch length, and radius of punch and molding curvature. The base deep drawing mold consists of three components: the punch, the base, and the punch guide. The punch is the positive mold, the base is the negative mold, and the punch guide is a passive element that helps align the pin with the base cavity and does not allow the material to unnecessarily deform during the process. Note the orientation in FIG. 11, where the punch inserts through the guide hole and into the base cavity, while the guide hole is aligned by guide pins and an filleted corner on both the base and guide hole components to ensure proper assembly. The deep drawing process is as follows, the ceramic material is inserted between the base and the guide components. The pin is then pressed down to draw the material into the base cavity. To account for the space occupied by the material, there exists at minimum a 1.2 mm gap between all positive and negative mold interfaces. Three general sizes of molds were tested to determine continuity between scale-ups. Based on the smallest deep draw mold, the other two were scaled up by factors of 2 and 3 respectively. The pin lengths for each mold were selected using the ratio of the pin depth, d, when the pin is inserted into the mold and the diameter of the pin, D, giving the ratio R=d/D. Pins with lengths satisfying ratios of 1.0, 1.5, and 2.0 were manufactured and tested for each mold size-category.

The primary variables in deep drawing of all-ceramics are the melting temperature of the matrix, the force F of the draw pin, the strain rate of the draw pin, the punch diameter, the pre-formed diameter, the clearance between the base hole and pin diameter, the pin tip radius, the base hole corner radius, the surface roughness of the mold, the contact force between the guide mold and the material, and the lubrication between all contacting surfaces. The deep drawing molds were tested with a high-temperature mold release that was rated up to 800° C. During all tests the diameter of the sample was measured before and after testing. It was observed that during the deep drawing process, the sample diameter did not change. Therefore, only extrusion of the material actually occurred and not actual drawing. This may have been due to the extremely rough surface of the printed molds. Other variables may also have caused premature failure. It was also observed that, as the temperature increased, the necessary loading for deformation significantly decreased. This was expected because the reduced matrix activation energy needed for flow to occur reduces as temperature increases. However, an interesting trend between the mold sizes showed that as the punch diameter decreased so did the draw ratio. This was most likely attributed to the clearance between the punch diameter and base hole. The limit to the material was met at the maximum of the 1:1 ratio pin and the sample tore. Further, the draw depth ratio never exceeded 110%, for the best samples using the small mold, without failure.

### Raspberry Pi Stress Test and FLIR Imaging

### Program Running

Evaluating the potential for thermal management of these thermoformed ceramic materials was tested by using a simple Raspberry Pi PCB as a proof-of-concept. To measure the internal thermal couples and external surface temperature two separate methods were applied. The internal thermal couples along with a custom software measured the core temperature of the CPU under different loading conditions. The loading profile was set to idling conditions for 30 seconds, throttled for 10 minutes, and then back to the idling condition for 2.5 minutes.

### Data Processing

The temperature was monitored every second during the time profile, and the data was saved to a text file for post processing. Once the data was collected, it was transferred to Excel for calculations and then to OriginPro plotting software for data visualization. The data was analyzed by plotting the raw data to understand the cooling capacity difference between each heat sink, and then was normalized by the height of each heat sink, promoting the advantage of the low profile design of the thermoformed heat sink.

### FLIR Imaging

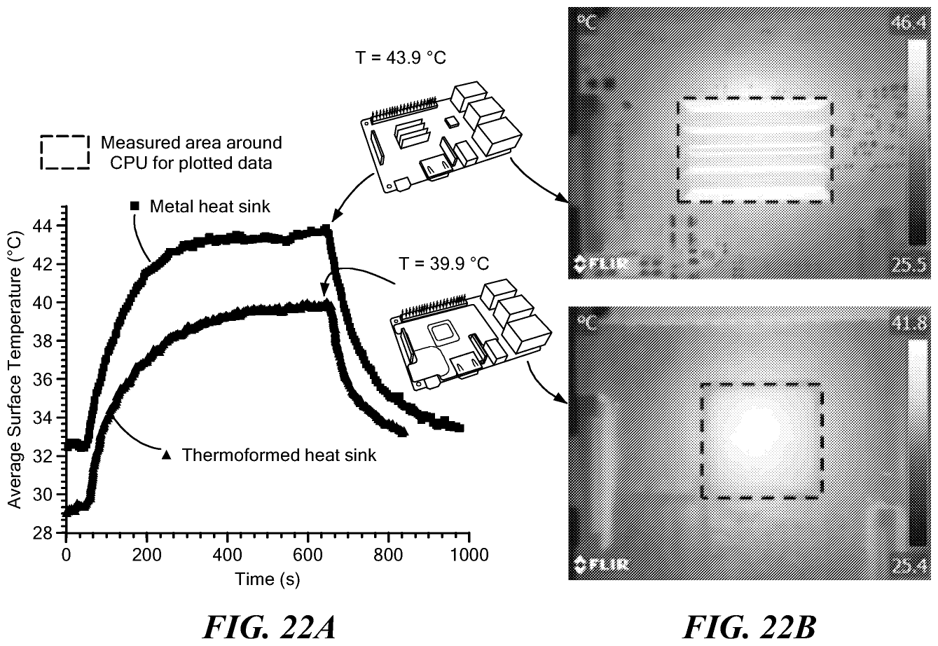

Referring to FIGS. 22A and 22B, the surface temperature was measured with a FLIR EST230 infrared camera. To control the emissivity between the metal and ceramic surfaces, they were both coated with a dry carbon spray coating, following the same protocol for the laser flash method from ASTM E1416. Three coats were applied to each heat sink. Each coating was allowed to dry for 10 minutes between coats. The FLIR camera recorded and plotted the data live. The data was then extracted and post processed with a plotting software, and the live plot movie was developed using Matlab.

FIG. 22A shows the carbon coated heat sinks to ensure the emissivity value of 0.96 was the same for both materials. The plotted surface temperature shows a difference of 4° C., the same as in the internal thermal couple data described herein. In FIG. 22B, the FLIR thermal still images show the thermal features of each heat sink and the scale bar that represents the temperature spectrum of the image.

As used herein, “consisting essentially of” allows the inclusion of materials or steps that do not materially affect the basic and novel characteristics of the claim. Any recitation herein of the term “comprising,” particularly in a description of components of a composition or in a description of elements of a device, can be exchanged with “consisting essentially of” or “consisting of.”

The present technology has been described in conjunction with certain preferred embodiments and aspects. It is to be understood that the technology is not limited to the exact details of construction, operation, exact materials or embodiments or aspects shown and described, and that various modifications, substitution of equivalents, alterations to the compositions, and other changes to the embodiments and aspects disclosed herein will be apparent to one of skill in the art.

U.S. Pat. No. 10,834,854 is hereby incorporated by reference in its entirety.

What is claimed is:

1. A process for manufacturing a molded ceramic composite material, the process comprising:
(a) providing a preform having a first configuration and having two opposed surfaces, the preform comprising a ceramic composite material, the material comprising ceramic particles within a ceramic matrix, wherein the ceramic particles have a platelet configuration disposed in a parallel alignment transverse to a thickness direction extending between the two opposed surfaces of the first configuration;
(b) thermoforming the preform, comprising the steps of:
(i) heating the preform in a mold to a temperature greater than a melting or softening temperature of the ceramic matrix and preferably less than a melting or degradation temperature of the ceramic particles, and
(ii) applying a load to the mold, whereby the first configuration of the preform within the mold is converted to a second configuration to form the molded ceramic composite material;
(c) cooling the molded ceramic composite material in the mold; and
(d) removing the molded ceramic composite material from the mold.

2. The process of claim 1, wherein the step of providing the preform comprises:
(a-1) providing a slurry comprising a plurality of the ceramic particles in a polymeric binder;
(a-2) vibrating the slurry to provide a suspension in which the slurry fluidizes;
(a-3) forming the slurry in a layer on a stage or in a preform mold, wherein the ceramic particles become aligned in the parallel alignment;
(a-4) consolidating the polymeric binder to form a solid green body comprising the ceramic particles maintained in the parallel alignment;
(a-5) debinding the solid green body at a first temperature at which the polymeric binder decomposes, leaving a ceramic body comprising the ceramic matrix and the ceramic particles; and
(a-6) sintering the ceramic body at a second temperature greater than the first temperature, whereby the ceramic particles remain in the parallel alignment in the ceramic matrix.

3. The process of claim 2, wherein in step (a-6) the ceramic particles become partially oxidized.

4. The process of claim 2, wherein the slurry provided in (a-1) further comprises one or more photoinitiators and one or more diluents mixed together with the ceramic particles and the polymeric binder, and wherein the slurry flows under shear stress.

5. The process of claim 2, wherein the polymeric binder is selected from the group consisting of a polymerizable resin, an epoxy, a molten thermoplastic, and a solvent-based thermoplastic.

6. The process of claim 5, wherein the polymerizable resin comprises acrylate, methacrylate, polymethyl methacrylate, thiolene resin, epoxy resin, thermoplastic polymer, wax, methylcellulose, phenolic resin, polyvinyl acetate, polyvinyl alcohol, or caoutchouc glue.

7. The process of claim 2, wherein in the consolidating step of (a-4), consolidating the polymeric binder comprises curing the polymeric binder at a curing temperature to form the solid green body.

8. The process of claim 2, wherein the polymeric binder is an oxygen-donating material and wherein, in the consolidating step of (a-4), the polymeric binder donates oxygen for seeding an oxidation process at the ceramic particles.

9. The process of claim 2, wherein the step (a-3) of forming the slurry in the layer comprises tape casting the slurry on the stage or depositing the slurry in the preform mold.

10. The process of claim 2, wherein the step (a-2) of vibrating the slurry occurs before the step of forming the slurry in the layer, during the step (a-3) of forming the slurry in the layer, after the step (a-3) of forming the slurry in the layer, or a combination thereof.

11. The process of claim 2, wherein the steps (a-2) of vibrating the slurry and (a-3) of forming the slurry in the layer are repeated a plurality of times to form the sheet.

12. The process of claim 2, wherein the polymeric binder is a photopolymerizable resin, and the step (a-4) of consolidating the polymeric binder comprises applying ultraviolet or visible light to the slurry.

13. The process of claim 1, wherein in thermoforming step (b), the temperature to which the preform is heated is below a degradation temperature and/or an evaporation temperature of the ceramic matrix.

14. The process of claim 1, wherein in thermoforming step (b), the preform is heated to a temperature from about 400° C. to about 1000° C., or from about 500° C. to about 700° C.

15. The process of claim 1, wherein in step (b) (ii) of applying the load, the load stress ranges from about 50 kPa to about to 100 MPa, or from about 500 kPa to 5 MPa.

16. The process of claim 1, wherein in thermoforming step (b) the mold comprises a lower part having a negative surface and an upper part having a positive surface, and wherein the load is applied to the preform through the upper part of the mold.

17. The process of claim 1, wherein in thermoforming step (b), the mold comprises a negative surface and a positive surface, and each surface includes at least one surface feature having a feature size of about 1 mm or less in any dimension.

18. The process of claim 17, wherein said feature size is about 200 μm or less in any dimension.

19. The process of claim 1, wherein in thermoforming step (b), the mold has a maximum draw ratio of feature height to feature width of about 1 to 1.

20. The process of claim 1, wherein the ceramic particles comprise an oxide, a nitride, a carbide, a sulfide, a fluoride, or a combination thereof in flake form.

21. The process of claim 1, wherein the ceramic particles are hexagonal boron nitride, hexagonal aluminum nitride, aluminum oxide, molybdenum disulfide, clay, cesium oxide, graphene, flake-like ferrites, calcium phosphate flakes, zirconia flakes, silica flakes, or a combination thereof.

22. The process of claim 1, wherein the ceramic matrix comprises boron oxide, silicon dioxide, glass flake, silver coated glass flake, a lithium oxide-silica mixture, a magnesium oxide-silica mixture, or a combination thereof.

23. The process of claim 1, wherein the ceramic matrix comprises a glassy material or a glassy-ceramic material mixture having a softening phase or melting temperature within a working service temperature range of a material forming the mold and below a melting temperature or degradation temperature of the ceramic particles.

24. The process of claim 1, wherein the ceramic particle concentration in the molded ceramic composite material is from about 30 wt % to about 90 wt % and the ceramic matrix concentration is from about 10 wt % to about 70 wt %.

25. The process of claim 1, wherein the ceramic particles in the molded ceramic composite material have a diameter from about 1 μm to about 100 μm, or from about 5 μm to about 45 μm, and a thickness from about 3 to about 100 times less than the diameter.

26. The process of claim 1, wherein the preform has a thickness from about 0.05 mm to about 10 mm, or from about 0.1 mm to 3 mm.

27. The process of claim 1, wherein the molded ceramic composite material has a thickness from about 0.05 mm to about 10 mm, or from about 0.1 mm to about 3 mm.

28. The process of claim 1, wherein the ceramic particles comprise phononic crystal particles.

29. The process of claim 1, wherein transverse bonds between layers of the ceramic particles within the preform are sufficiently weak to allow slippage of the ceramic particles when subjected to the load in thermoforming step (b)(ii).

30. The process of claim 1, wherein the molded ceramic composite material has an in-plane thermal conductivity, transverse to the thickness dimension, greater than a through-plane thermal conductivity.

31. The process of claim 1, wherein the molded ceramic composite material has an in-plane thermal conductivity, transverse to the thickness dimension, from about 5 W/mK to about 100 W/mK, or from about 10 W/mK to about 40 W/mK, at ambient temperature.

32. The process of claim 1, wherein the molded ceramic composite material is configured as a thermal management device, a heat sink or a heat spreader for a printed circuit board, a heat exchanger, a cold plate, a low-loss dielectric RF component, a radome, a power inverter, a solar cell, a neutron shield, a high temperature heat shield, a heat shield for a cube satellite, an encapsulant, or a medical device.

33. A method of fabricating a thermal management device for a heat producing component, the method comprising:
(a) providing a mold configured to conform to at least a portion of the heat producing component; and
(b) fabricating a molded ceramic composite material according to the process of any of the preceding claims using the mold provided in present step (a) to form the thermal management device.

34. The method of claim 33, further comprising:
(c) fitting the molded ceramic composite material to the heat producing component or portion thereof.

35. The method of claim 33, wherein the heat producing component is a printed circuit board, a central processing unit, a high-density electronic platform, an electronic chassis, an RF device, an RF or phased antenna array, a low-loss dielectric RF component, a radome, a power inverter, a solar cell, a neutron shield, a cube satellite, or a medical device.

36. A method of fabricating a thermal management device, the method comprising:
(a) providing a design for a heat producing component or portion thereof requiring thermal management;
(b) fabricating a preform mold designed to conform to a first configuration complementary to the heat producing component or portion thereof;
(c) fabricating a mold designed to conform to a second configuration complementary to the heat producing component or portion thereof, wherein the second configuration is more precisely complementary to the heat producing component or portion thereof than the first configuration;
(d) fabricating a preform using the preform mold, wherein the preform has said first configuration and has two opposed surfaces, wherein the preform comprises a ceramic matrix composite material, the material comprising ceramic particles within a ceramic matrix, wherein the ceramic particles have a platelet configuration disposed in a parallel alignment transverse to a thickness direction extending between the two opposed surfaces;
(e) thermoforming the preform within the mold to provide a thermal management device in said second configuration, said thermoforming comprising
(i) heating the preform in the preform mold to a temperature greater than a melting or softening temperature of the ceramic matrix, and
(ii) applying a load to the preform mold, whereby the first configuration of the preform within the mold is converted to the second configuration to form the thermal management device;
(f) cooling the thermal management device in the mold; and
(g) removing the thermal management device from the mold.

37. The method of claim 36, wherein in step (a) the design comprises a negative geometry of the heat producing component or portion thereof provided by a three-dimensional computer-aided design model of the heat producing component or portion thereof or through a three-dimensional scan of the heat producing component or portion thereof.

38. The method of claim 36, wherein step (b) comprises fabricating the preform mold and/or the mold from a metal material by an additive manufacturing process or a machining process based on a three-dimensional computer-aided design model of the design of the heat producing component or portion thereof.

39. The method of claim 38, wherein the additive manufacturing process is a three-dimensional printing process, a stereolithography process, a direct write process, a fused deposition process, or a selective sintering process with heat or laser.

40. A device for thermal management of a heat producing component, wherein the device is fabricated by the process of claim 1.

41. A device for thermal management of a heat producing component, the device comprising:
a body comprising a ceramic matrix composite material, the material comprising a plurality of ceramic particles within a ceramic matrix and comprising two opposed surfaces, the ceramic particles having a platelet configuration disposed in parallel alignment and transverse to a thickness direction extending between the two opposed surfaces; and
wherein the body is formed with at least one deformation to accommodate a surface feature of said component, the parallel alignment of the platelet configuration conforming to at least one dimension of the at least one deformation.

42. The device of claim 41, wherein the ceramic particles comprise hexagonal boron nitride, boron oxide, hexagonal aluminum nitride, aluminum oxide, molybdenum disulfide, clay, cesium oxide, graphene, flake-like ferrites, calcium phosphate flakes, zirconia flakes, silica flakes, or a combination thereof.

43. The device of claim 41, wherein the ceramic matrix comprises boron oxide, silicon dioxide, glass flake, silver coated glass flake, a lithium oxide-silica mixture, a magnesium oxide-silica mixture, or a combination thereof.

44. The device of claim 41, wherein the ceramic particle concentration in the ceramic matrix composite material of the body is from about 30 wt % to about 90 wt % and the ceramic matrix concentration in the ceramic matrix composite material of the body is from about 10 wt % to about 70 wt %.

45. The device claim 41, wherein the ceramic particles in the ceramic matrix composite material of the body have a diameter from about 1 μm to about 100 μm, or from about 5 μm to about 45 μm, and a thickness from about 3 to about 100 times less than the diameter.

46. The device of claim 41, wherein the body has a thickness from about 0.05 mm to about 10 mm, or from about 0.1 mm to 3 mm.

47. The device of claim 41, wherein the ceramic particles comprise phononic crystal particles.

48. The device of claim 41, wherein the body has an in-plane thermal conductivity, transverse to the thickness dimension, greater than a through-plane thermal conductivity.

49. The device of claim 41, wherein the body has an in-plane thermal conductivity, transverse to the thickness dimension, from about 5 W/mK to about 100 W/mK, or from about 10 W/mK to about 40 W/mK, at ambient temperature.
